(19) United States
(12) Patent Application Publication
(10) Pub. No.: US 2006/0226562 A1
(43) Pub. Date: Oct. 12, 2006

(54) Diffuse reflective polarizing films with orientable polymer blends

(75) Inventors: Matthew B. Johnson, St. Paul, MN (US); Martin E. Denker, Vadnais Heights, MN (US); Kristopher J. Derks, Woodbury, MN (US); Timothy J. Hebrink, Scandia, MN (US); Richard J. Thompson, Lino Lake, MN (US); Robert D. Taylor, Stacy, MN (US); Matthew J. Michel, St. Paul, MN (US); Mark B. O'Neill, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/398,276

(22) Filed: Apr. 5, 2006

Related U.S. Application Data
(60) Provisional application No. 60/668,944, filed on Apr. 6, 2005.

(51) Int. Cl. B29D 7/01; C08L 67/00; C08L 69/00

(52) U.S. Cl. 264/1.34; 525/439

(57) ABSTRACT

A polarizing film includes a first phase of a first polymer having a birefringence of at least 0.05 and a second phase of a second polymer disposed within the first phase. The index of refraction difference between the first and second phases is greater than about 0.05 along a first axis and is less than about 0.05 along at least one axis orthogonal to the first axis. The diffuse reflectivity of the first and second phases taken together along at least one axis for at least one polarization state of electromagnetic radiation may be at least about 30%. In some exemplary embodiments, the second phase has a refractive index of about 1.53 to about 1.59. In some exemplary embodiments, the second polymer has a glass transition temperature (Tg) higher than the Tg of the birefringent first polymer.

### CROSS-REFERENCE TO RELATED APPLICATIONS

This non-provisional application claims the benefit of priority from U.S. Provisional Application Serial No. 60/668,944, filed Apr. 6, 2005, entitled, “Diffuse Reflective Polarizing Films with Orientable Polymer Blends.”

### TECHNICAL FIELD

This disclosure relates to optical films that contain structures suitable for controlling optical characteristics, such as control of specific polarizations of reflected or transmitted light, and methods of making such optical films. More particularly, this disclosure relates to polymer blends for use in reflective polarizing film constructions and methods of processing such constructions, particularly substantially uniaxial orientation processes.

### SUMMARY

In one aspect, the present disclosure is directed to a polarizing film including a first phase of a first polymer and a second phase of a second polymer disposed within the first phase, and wherein the index of refraction difference between the first and second phases is greater than about 0.05 along a first axis and is less than about 0.05 along at least one axis orthogonal to the first axis. The diffuse reflectivity of the first and second phases taken together along at least one axis for at least one polarization state of electromagnetic radiation may be at least about 30%. The second phase may have a refractive index of about 1.53 to about 1.59.

In another aspect, the present disclosure is directed to a method of forming an optical film, including forming a film including a first phase of a first polymer and a second phase of a second polymer disposed in the first phase, wherein the second polymer has a refractive index of about 1.53 to about 1.59; conveying the film into a stretcher along a machine direction while holding opposing edge portions of the film, and; (c) substantially uniaxially stretching the film within the stretcher by moving the opposing edge portions of the film along diverging paths, wherein following stretching the index of refraction difference between the first and second phases is greater than about 0.05 along a first axis in a plane parallel to a surface of the film, and less than about 0.05 along at least one axis orthogonal to the first axis.

In yet another aspect, the present disclosure is directed to a polarizing film including a continuous phase of a first polymer and a disperse phase of a second polymer, different from the first polymer, wherein the index of refraction difference between the continuous and disperse phases is greater than about 0.05 along a first axis in a plane parallel to a surface of the film, and less than about 0.05 along a second axis orthogonal to the first axis. The second polymer may have a glass transition temperature (Tg) higher than the Tg of the birefringent first polymer.

The additional details of one or more exemplary embodiments of the present disclosure are set forth in the accompanying drawings and the description below. Other features, objects, and advantages of the present disclosure will be apparent from the description and drawings, and from the claims.

### BRIEF DESCRIPTION OF DRAWINGS

FIG. 1 is a schematic drawing illustrating an optical body made in accordance with the present disclosure, wherein the disperse phase is arranged as a series of elongated masses having an essentially circular cross-section;

FIG. 2 is a schematic drawing illustrating an optical body made in accordance with the present disclosure, wherein the disperse phase is arranged as a series of elongated masses having an essentially elliptical cross-section;

FIG. 3 is a schematic top view of a prior art tenter apparatus used to stretch film;

FIG. 4 is a schematic perspective view of a portion of film in the prior art process depicted in FIG. 3 both before and after stretching;

FIG. 5 is a schematic side view of a stretched film illustrating an initial thickness T, a final thickness T′ and the normal direction ND;

FIG. 6 is a schematic view of a stretched film illustrating a coordinate axis system showing a machine direction (MD), a normal direction (ND), a transverse direction (TD), an initial length Y, and a stretched length Y′;

FIG. 7 is a schematic view of a stretched film illustrating a coordinate axis system showing a machine direction (MD), a normal direction (ND) a transverse direction (TD), an initial width X, and a stretched width Xₒ;

FIG. 8 is a schematic illustration of a prior art batch process for drawing an optical film showing the film both before and after the stretch;

FIG. 9 is a schematic diagram of an Interpenetrating Polymer Network (IPN);

FIGS. 10(a-e) are schematic drawings illustrating various shapes of the disperse phase in an optical body made in accordance with exemplary embodiments of the present disclosure;

FIG. 11(a) is a graph of the bidirectional scatter distribution as a function of scattered angle for an oriented film in accordance with the present disclosure for light polarized perpendicular to orientation direction;

FIG. 11(b) is a graph of the bidirectional scatter distribution as a function of scattered angle for an oriented film in accordance with the present disclosure for light polarized parallel to orientation direction;

FIG. 12 is a perspective view of a portion of film in the process depicted in FIG. 13 both before and after the stretching process;

FIG. 13 is a schematic illustration of the stretching process according to an exemplary embodiment of the present disclosure;

FIG. 14 is a schematic illustration of one embodiment of a take-away system for a stretching apparatus according to the present disclosure;

FIG. 15 is a schematic illustration of another embodiment of a take-away system for a stretching apparatus;

FIG. 16 is a schematic representation of a multilayer film made in accordance with the present disclosure;

FIG. 17 is a plot of the pass and block state spectra for an embodiment of the film of the present disclosure;

FIGS. 18 (a) and (b) are pass and block spectra, respectively, for an embodiment of the film of the present disclosure;

FIG. 19 is a plot of the pass and block state spectra for an embodiment of the film of the present disclosure; and

FIG. 20 is a plot made using Differential Scanning Calorimetry (DSCO) that shows the glass transition temperature (Tg) of a PEN:PC blend according to an embodiment of the present disclosure.

While the above-identified drawing figures set forth several exemplary embodiments of the disclosure, other embodiments are also contemplated. This disclosure presents illustrative embodiments of the present invention by way of representation and not limitation. Numerous other modifications and embodiments can be devised by those skilled in the art which fall within the scope and spirit of the principles of the present disclosure. The drawing figures are not drawn to scale.

Moreover, while embodiments and components are referred to by the designations “first,” “second,” “third,” etc., it is to be understood that these descriptions are bestowed for convenience of reference and do not imply an order of preference. The designations are presented merely to distinguish between different embodiments for purposes of clarity.

Unless otherwise indicated, all numbers expressing feature sizes, amounts, and physical properties used in the specification and claims are to be understood as being modified in all instances by the term “about.” Accordingly, unless indicated to the contrary, the numbers set forth are approximations that can vary depending upon the desired properties using the teachings disclosed herein.

### DESCRIPTION

Polymeric films having desired optical properties can be constructed from inclusions made of a polymer dispersed within a continuous matrix of another polymer. The polymer forming the inclusions may be selected to provide a range of reflective and transmissive properties to the film. These characteristics include inclusion size with respect to wavelength within the film, inclusion shape and alignment, and the degree of refractive index match and/or mismatch between the disperse phase and the continuous matrix along the film's three orthogonal axes.

In the alternative, if the volume fractions for binary blends of high polymers of roughly equivalent viscosity are comparable, e.g., each is greater than about 40% and approaches 50%, the distinction between the disperse and continuous phases becomes difficult, as each phase becomes continuous in space. Depending upon the materials of choice, there may also be regions where the first phase appears to be dispersed within the second, and vice versa. These materials, which may be referred to as co-continuous phases, are discussed in more detail below.

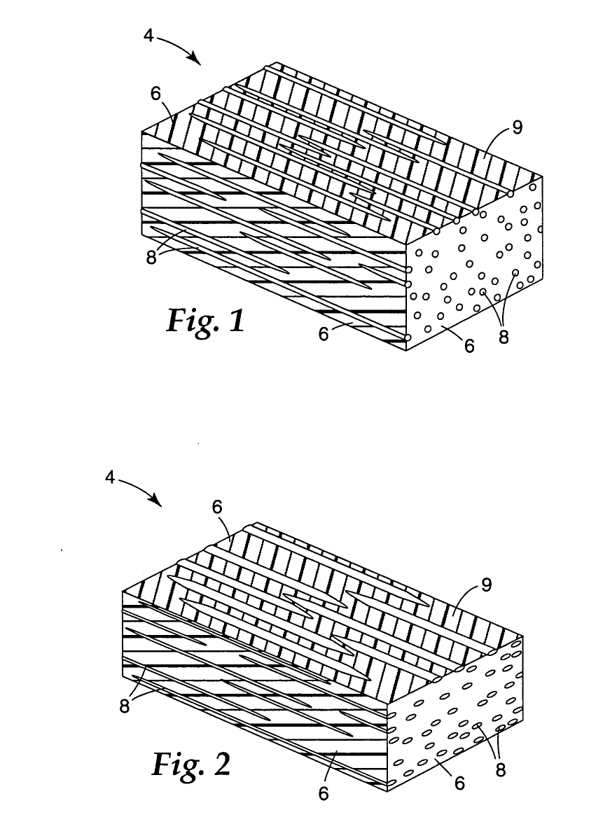

Referring to FIGS. 1-2, an embodiment of a diffusely reflective polarizing optical film 4 described, for example, in U.S. Pat. Nos. 5,825,543, 6,057,961, 6,590,705, and 6,057,961, incorporated herein by reference, includes a material with a birefringent matrix or continuous phase 6 of a first thermoplastic polymer and a discontinuous or disperse phase 8 of a second thermoplastic polymer. In an alternative embodiment not shown in FIGS. 1-2, the second thermoplastic polymer may make up the continuous phase, with the birefringent material forming the disperse phase.

The first and second polymers are selected to have a large difference between the indices of refraction of the continuous and disperse phases along a first axis in a plane parallel to a surface of the optical film and small difference between the indices of refraction along at least one other axis parallel to the surface of the optical film. More preferably, the first and second polymers are selected to have a large difference between the indices of refraction of the continuous and disperse phases along a first axis in a plane parallel to a surface of the optical film and small difference along the other two orthogonal axes.

Preferably, the indices of refraction of the first and second polymers are substantially mismatched (differ by more than about 0.05) along the first axis in the plane of the material, and are substantially matched along at least one other axis in the plane of the material (differ by less than about 0.05). More preferably, the indices of refraction are substantially mismatched (differ by more than about 0.05) along the first axis in the plane of the material, and are substantially matched along the other two orthogonal axes (differ by less than about 0.05). The mismatch in refractive indices along a particular axis substantially scatters incident light polarized along that axis, resulting in a significant amount of reflection. In contrast, incident light polarized along an axis along which the refractive indices are matched will be spectrally transmitted or reflected with a much lesser degree of scattering.

The polymers selected for at least one of the continuous and/or disperse phases in the film preferably undergo a change in refractive index as the film is oriented. As the film is oriented in one or more directions, refractive index matches or mismatches are produced along one or more axes. By careful manipulation of orientation parameters and other processing conditions, the positive or negative birefringence of the matrix or the disperse phase can be used to induce diffuse reflection or transmission of one or both polarizations of light along a given axis. Preferably, the diffuse reflectivity of the first and second phases taken together along at least one axis for at least one polarization state of electromagnetic radiation is at least about 30%.

As used herein, the terms “specular reflection” and “specular reflectance” refer to the reflectance of light rays into an emergent cone with a vertex angle of 16 degrees centered around the specular angle. The terms “diffuse reflection” or “diffuse reflectance” refer to the reflection of rays that are outside the specular cone defined above. The terms “total reflectance” or “total reflection” refer to the combined reflectance of all light from a surface. Thus, total reflection is the sum of specular and diffuse reflection.

Similarly, the terms “specular transmission” and “specular transmittance” are used herein in reference to the transmission of rays into an emergent cone with a vertex angle of 16 degrees centered around the specular direction. The terms “diffuse transmission” and “diffuse transmittance” are used herein in reference to the transmission of all rays that are outside the specular cone defined above. The terms “total transmission” or “total transmittance” refer to the combined transmission of all light through an optical body. Thus, total transmission is the sum of specular and diffuse transmission.

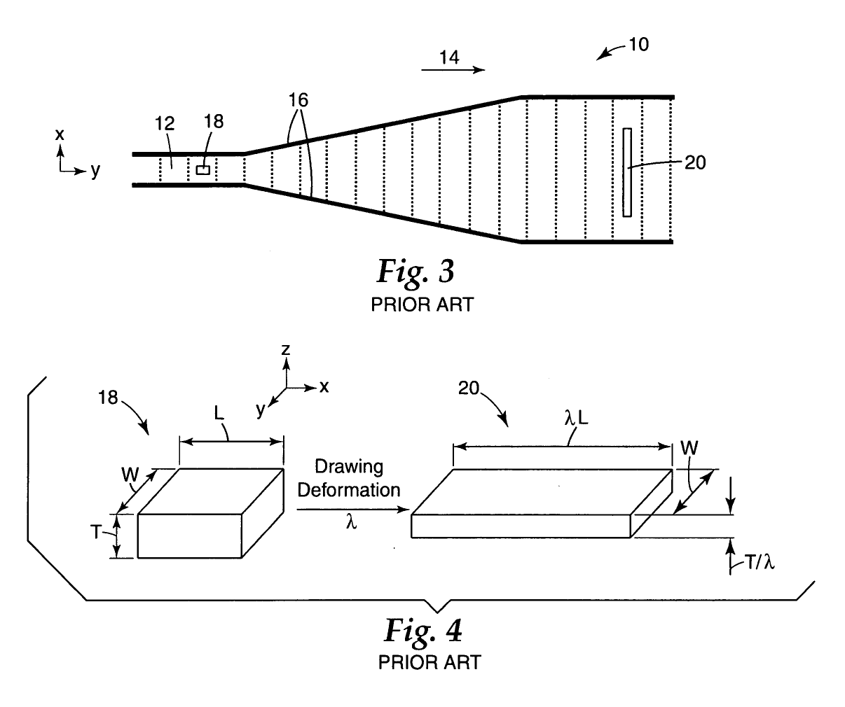

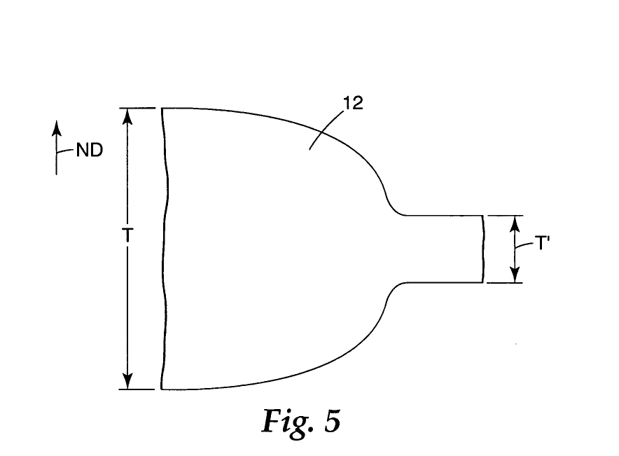

The film may be oriented by a wide variety of processes. For example, FIG. 3 illustrates a conventional tenter stretching process 10 that stretches continuously fed films 12 transversely to the direction of film travel 14. The film 12 is gripped at both edges 16 by a gripping apparatus, typically an arrangement of tenter clips (not shown in FIG. 3). The tenter clips may be connected to tenter chains that ride along linearly diverging tenter tracks or rails. This arrangement propels the film 12 forward in a machine direction (MD) of film travel 14 and stretches the film 12 in a transverse or tenter direction (TD). Thus an initial, unoriented portion 18 in the film may be stretched to the final, oriented portion 20 in one example. Referring to FIG. 4, the unstretched portion 18 of the film 12 shown in FIG. 1 may have dimensions T, W and L. After the film 12 is stretched by a factor of lambda, the dimensions of that portion of film have changed to those shown on portion 20.

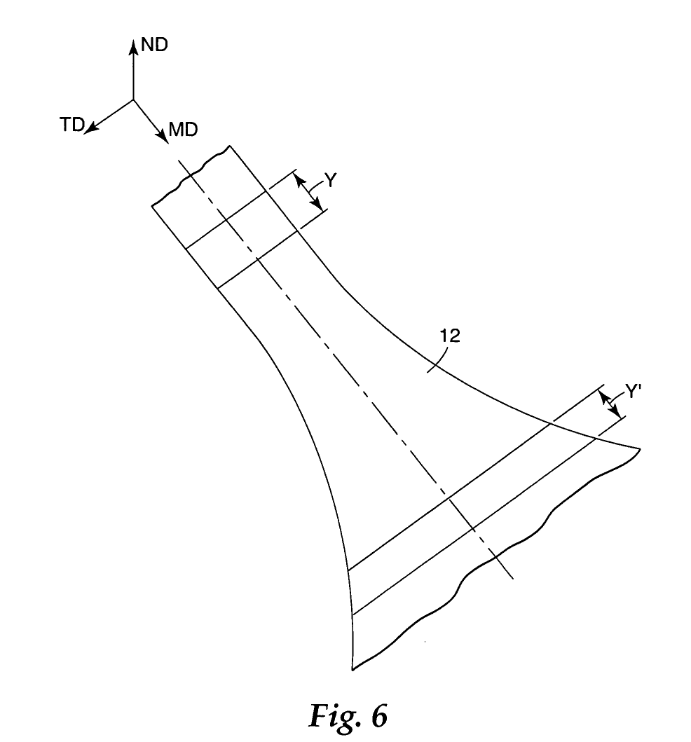

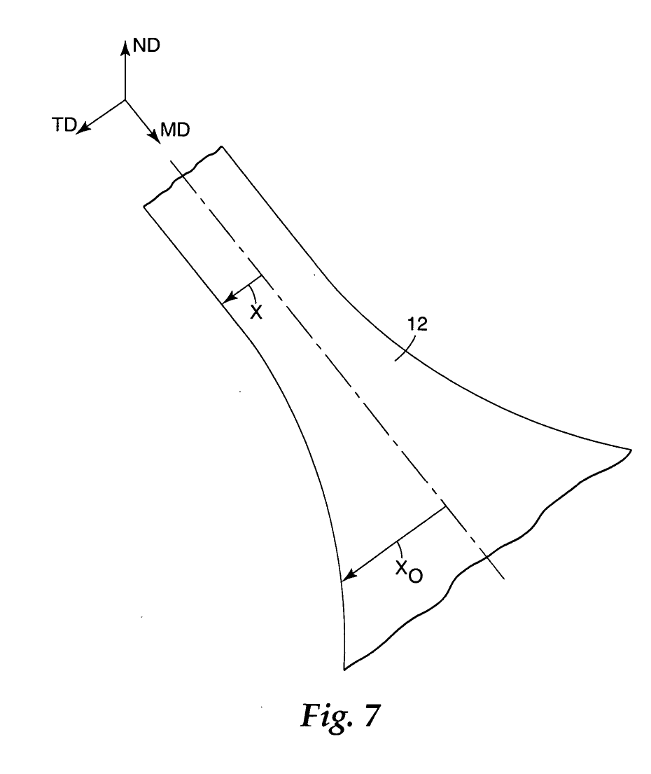

Referring to FIG. 5, in the conventional tenter, the thickness T of the film before stretching is greater than its thickness after stretching, T′: the film becomes thinner. The ratio of T′ to T may be defined as the normal (z) direction (with respect to the plane of the film) draw ratio (NDDR). As shown in FIG. 6, in the machine direction 14, the length of a portion of film after stretching, Y′, divided by the length of a portion of film prior to stretching, Y, is referred to as the machine direction draw ratio (MDDR). The transverse direction draw ratio (TDDR) may be defined as the width of a portion of the film after stretching, X′, divided by the initial width of that portion X. For illustrative purposes only, see Xₒ/X in FIG. 7.

The NDDR is roughly the reciprocal of the TDDR in a conventional tenter, while the MDDR is essentially unchanged. In other words, the film grows in a direction transverse to the machine direction (MD) as it is stretched, and it becomes thinner in the normal, or Z, direction. This asymmetry in MDDR and NDDR causes differences in the various molecular, mechanical and optical properties of the film. Illustrative examples of such properties include the crystal orientation and morphology, thermal and hydroscopic expansions, the small strain anisotropic mechanical compliances, tear resistance, creep resistance, shrinkage, and the refractive indices and absorption coefficients at various wavelengths.

For the birefringent component in the film construction, materials with positive birefringence are preferred in one embodiment, while birefringent polyesters are particularly preferred. A particularly suitable example of a birefringent material is a birefringent polyester containing naphthalene dicarboxylate functionality, particularly 2,6 polyethyelene napthalate (PEN). For example, if PEN is selected as the first birefringent polymer for the film construction, the cast, unoriented film has the same index of refraction in each of its mutually orthogonal axes (nx=ny=nz=1.64). After orientation in a conventional tenter, the polymer is stretched along the transverse direction and the TDDR (x′/x) increases. This increase in TDDR is accompanied by an increase in refractive index from about 1.64 to about 1.86 along the x direction (nx). Since the film is constrained by tenter clips and is not allowed to relax along the machine direction (MD), the MDDR remains approximately the same as in the unoriented cast film, and the refractive index (ny) along the Y direction is slightly reduced from the original 1.64 to about 1.61. The oriented film thus has an in plane refractive index difference of nx−ny=about 0.22. Since mass of the film must be conserved, the NDDR (T′/T) decreases, and the index of refraction along the z direction normal to the plane of the film is reduced to about 1.51 (nz=1.51).

The first and second polymers may be selected such that the indices of refraction of the continuous and disperse phases are substantially matched (i.e., differ by less than about 0.05) along two of three mutually orthogonal axes, and are substantially mismatched (i.e., differ by more than about 0.05) along the other mutually orthogonal axis. Therefore, in one embodiment, the second (i.e. non-birefringent) polymer in the film construction has a refractive index selected to provide a minimum block state transmission and maximum pass state transmission at normal incidence. Additional considerations for selecting the second polymer include thermal melt stability, melt viscosity, UV stability, cost and the like.

There are only a few commercially available polymers with refractive indices that sufficiently match, following orientation, the refractive indices of a birefringent material such as PEN in the ny and nz direction. When PEN is used as the continuous phase in the optical material, the other phase is, given appropriate process conditions for the tentering process of FIGS. 3-4, is preferably selected from syndiotactic vinyl aromatic polymers, such as polystyrene (sPS) in one embodiment.

When the film is to be used as a polarizer, it is preferably oriented by stretching and allowing some dimensional relaxation in the cross stretch in-plane direction, so that the index of refraction difference between the first polymer making up the continuous phase and the second polymer making up the disperse phase is large along a first axis in a plane parallel to a surface of the material and small along the other two orthogonal axes. This results in a large optical anisotropy for electromagnetic radiation of different polarizations.

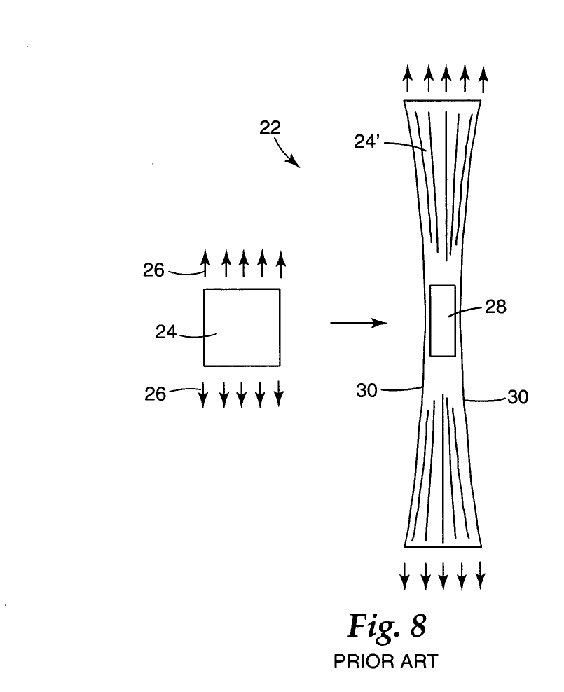

FIG. 8 illustrates a known batch technique 22 for stretching a multilayer film suitable for use as a component in an optical device such as a polarizer. The initial film 24 is stretched uniaxially in the direction of the arrows 26. The central portion 28 necks down so that two edges 30 of the film 24′ are no longer parallel after the stretching process. Much of the stretched film 24′ is unusable as an optical component. Only a relatively small central portion 28 of the film 24 is suitable for use in an optical component such as a polarizer.

Commonly owned U.S. Pat. Nos. 6,936,209; 6,949,212; 6,939,499; and 6,916,440, incorporated herein by reference, describe processes and apparatuses suitable for making exemplary embodiments of the present disclosure. For example, processes that may be used for making exemplary embodiments of the present disclosure include a continuous process for stretching an optical film, such as a multilayer optical film, referred to as true uniaxial stretching: the film is stretched along a first in-plane axis of the film (x direction) while allowing contraction of the film in the second in-plane axis (y or machine direction (MD)) and in the thickness (z or normal direction (ND)) of the film. The stretching is achieved by grasping edge portions of the film and moving the edge portions of the film along predetermined paths which diverge to create substantially the same, or at least similar, proportional dimensional changes in the second in-plane axis of the film (y) and in the thickness direction (z) of the film. In an exemplary embodiment, the edge portions of the film are moved along diverging predetermined paths that are substantially parabolic.

Since the nx following orientation in a substantially true uniaxial orientation process is substantially the same as in a conventional tenter, and the ny is lower, the resulting film also has enhanced optical power compared to a film stretched by a conventional tenter. For example, starting with a cast film of a birefringent first polymer such as PEN, with nx=ny=nz=1.64, and stretching using the processes described in U.S. Pat. Nos. 6,936,209; 6,949,212; 6,939,499; and 6,916,440, the resulting stretched film has nx=1.88 and ny=nz=1.57. The in-plane optical power (nx-ny) of the substantially uniaxially stretched film is therefore 0.31, compared to 0.22 for the same film stretched in a conventional tenter.

Since the index of refraction of the birefringent first polymer along the Y direction, ny, in the uniaxial orientation process is lower than the ny in a conventional tenter, a different polymeric material may be selected for the second polymer in the substantially uniaxially stretched film to provide index matching with the first polymer and form an efficient polarizer. In addition, since the substantially uniaxial orientation process provides enhanced optical power, a wider variety of material choices are available for the positively birefringent material to optimize other important film properties such as cost, environmental stability (such as, for example, UV stability and resistance to warping), optical properties and the like. Since the wide range of choices for the second polymer permits selection of materials with a Tg higher than the Tg of the first birefringent material, the film may be oriented at a temperature above the Tg of the first material, which provides improved environmental dimensional stability, resistance to creep and resistance to warping.

Referring again to FIGS. 1-2, in one embodiment, the exemplary embodiment is a diffusely reflective polarizing film 4 or other optical body that includes a birefringent matrix or continuous phase 6 and a discontinuous or disperse phase 8. In one embodiment, the index of refraction difference between the birefringent continuous phase 6 and the disperse phase 8 is large (i.e. mismatched) along a first axis in a plane parallel to a surface 9 of the film 4 and small (i.e. matched) along the other two orthogonal axes. In other exemplary embodiments, the disperse phase 8 may be birefringent. Preferably, the indices of refraction between the continuous phase 6 and the disperse phase 8 differ along the first axis in a plane parallel to the surface 9 of the film 4 by at least about 0.07, or more preferably, by at least about 0.1, and most preferably, by at least about 0.2. Preferably, the indices of refraction of the continuous and disperse phases 6, 8 differ by less than about 0.03 in each of the match directions, more preferably, less than about 0.02, and most preferably, less than about 0.01.

The birefringence of the continuous phase 6 or the disperse phase 8 is typically at least about 0.05, preferably at least about 0.1, more preferably at least about 0.15, and most preferably at least about 0.2.

The mismatch in refractive indices along a particular axis has the effect that incident light polarized along that axis will be substantially scattered, resulting in a significant amount of reflection. By contrast, incident light polarized along an axis in which the refractive indices are matched will be spectrally transmitted or reflected with a much lesser degree of scattering. This effect can be utilized to make a variety of optical devices, particularly high gain reflective polarizers with low loss and high extinction ratios. A wide range of materials is available for the disperse phase and the continuous phase, thus allowing for a high degree of control in providing optical bodies of consistent and predictable high quality performance.

### Materials for Continuous/Disperse Phases

Many different materials may be used as the continuous 6 or disperse 8 phase in the optical bodies 4 of the present disclosure, depending on the specific application to which the optical body 4 is directed. Such materials include inorganic materials such as silica-based polymers, organic materials such as liquid crystals, and polymeric materials, including monomers, copolymers, grafted polymers, and mixtures or blends thereof. The exact choice of materials for a given application will be driven by the desired match and mismatch obtainable in the refractive indices of the continuous 6 and disperse 8 phases along a particular axis, as well as the desired physical properties in the resulting product. However, in one embodiment, the materials of the continuous phase 6 will generally be characterized by being substantially transparent in the region of the spectrum desired.

A further consideration in the choice of materials is that the resulting product contains at least two distinct phases in an exemplary embodiment. This may be accomplished by casting the optical material from two or more materials which are immiscible with each other. Alternatively, if it is desired to make an optical material with a first and second material which are not immiscible with each other, and if the first material has a higher melting point than the second material, in some cases it may be possible to embed particles of appropriate dimensions of the first material within a molten matrix of the second material at a temperature below the melting point of the first material. The resulting mixture can then be cast into a film, with or without subsequent orientation, to produce an optical device.

Suitable polymeric materials for use as a birefringent phase include but are not limited to materials with positive birefringence, particularly birefringent polyesters, and more particularly birefringent polyesters with naphthalene carboxylate functionality. Suitable materials for the continuous phase 6 (which also may used in the disperse phase 8 in certain constructions) may be amorphous, semicrystalline, or crystalline polymeric materials, including materials made from monomers based on carboxylic acids such as isophthalic, azelaic, adipic, sebacic, dibenzoic, terephthalic, 2,7-naphthalene dicarboxylic, 2,6-naphthalene dicarboxylic, cyclohexanedicarboxylic, and bibenzoic acids (including 4, 4′-bibenzoic acid), or materials made from the corresponding esters of the aforementioned acids (i.e., dimethylterephthalate).

Of these, 2,6-polyethylene naphthalate (PEN), copolymers of PEN and polyethylene terepthalate (PET), PET, polypropylene terephthalate, polypropylene naphthalate, polybutylene terephthalate, polybutylene naphthalate, polyhexamethylene terephthalate, polyhexamethylene naphthalate, and other crystalline naphthalene dicarboxylic polyesters are particularly suitable. PEN and PET are especially suitable because of their strain induced birefringence, and because of their ability to remain permanently birefringent after stretching. PEN has a refractive index for polarized incident light of 550 nm wavelength which increases after stretching when the plane of polarization is parallel to the axis of stretch from about 1.64 to as high as about 1.9, while the refractive index decreases for light polarized perpendicular to the axis of stretch. PEN exhibits a birefringence (in this case, the difference between the index of refraction along the stretch direction and the index perpendicular to the stretch direction) of 0.25 to 0.40 in the visible spectrum. The birefringence can be increased by increasing the molecular orientation. PEN may be substantially heat stable from about 155° C. up to about 230° C., depending upon the processing conditions utilized during the manufacture of the film.

As noted above, the first and second polymers are selected such that the indices of refraction of the continuous and disperse phases are substantially matched (i.e., differ by less than about 0.05) along two of three mutually orthogonal axes, and are substantially mismatched (i.e., differ by more than about 0.05) along the other mutually orthogonal axis. Therefore, in one embodiment, the second (i.e. non-birefringent) polymer in the film construction has a refractive index selected to provide a minimum block state transmission and maximum pass state transmission at normal incidence. Additional considerations for selecting the second polymer include thermal melt stability, melt viscosity, UV stability, cost and the like. In one example, when PEN is used as one phase in the uniaxially stretched optical material of the present disclosure, the other phase is selected from substantially non-birefringent thermoplastic polymeric materials having refractive indices of about 1.53 to about 1.59, preferably about 1.56 to about 1.58, and more preferably about 1.57.

Suitable materials for the second polymer in the film construction include materials that are substantially non-positively birefringent when oriented under the conditions used to generate the appropriate level of birefringence in the first polymeric material. Suitable examples include polycarbonates (PC) and copolycarbonates, polystyrene-polymethylmethacrylate copolymers (PS-PMMA), PS-PMMA-acrylate copolymers such as, for example, those available under the trade designation MS 600 (50% acrylate content) from Sanyo Chemical Indus., Kyoto, Japan, NAS 21 (20% acrylate content) and NAS 30 (30% acrylate content) from Nova Chemical, Moon Township Pa., polystyrene maleic anhydride copolymers such as, for example, those available under the trade designation DYLARK from Nova Chemical, acrylonitrile butadiene styrene (ABS) and ABS-PMMA, polyurethanes, polyamides, particularly aliphatic polyamides such as nylon 6, nylon 6,6, and nylon 6,10, styrene-acrylonitrile polymers (SAN) such as TYRIL, available from Dow Chemical, Midland, Mich., and polycarbonate/polyester blend resins such as, for example, polyester/polycarbonate alloys available from Bayer Plastics under the trade designation Makroblend, those available from GE Plastics under the trade designation Xylex, and those available from Eastman Chemical under the trade designation SA 100 and SA 115, polyesters such as, for example, aliphatic copolyesters including CoPET and CoPEN, polyvinyl chloride (PVC), and polychloroprene.

In addition, although there are no particular restrictions regarding the molecular weight of these polymers, preferably, the weight average molecular weight is greater than 8,000 and less than 1,000,000, and more preferably, greater than 10,000 and less than 800,000.

### Volume Fraction of Disperse Phase

The volume fraction of the disperse phase also affects the scattering of light in the optical bodies of the present disclosure. Within certain limits, increasing the volume fraction of the disperse phase tends to increase the amount of scattering that a light ray experiences after entering the body for both the match and mismatch directions of polarized light. This factor is important for controlling the reflection and transmission properties for a given application.

The desired volume fraction of the disperse phase will depend on many factors, including the specific choice of materials for the continuous and disperse phases. However, the volume fraction of the disperse phase will typically be at least about 1% by volume relative to the continuous phase, more preferably within the range of about 5 to about 50%, and most preferably within the range of about 25 to about 45%. However, in other exemplary embodiments, the volume fraction of the disperse phase may be different, depending on the specific materials used and the desired properties of the optical film.

### Co-Continuous Phases

When the volume fraction for binary blends of high polymers of roughly equivalent viscosity is greater than about 40% and approaches 50%, the distinction between the disperse and continuous phases becomes difficult, as each phase becomes continuous in space. Depending upon the materials of choice, there may also be regions where the first phase appears to be dispersed within the second, and vice versa. For a description of a variety of co-continuous morphologies and for methods of evaluating, analyzing, and characterizing them, see Sperling and the references cited therein (L. H. Sperling, “Microphase Structure,” Encyclopedia of Polymer Science and Engineering, 2nd Ed., Vol. 9, 760-788, and L. H. Sperling, Chapter 1, “Interpenetrating Polymer Networks: An Overview,” Interpenetrating Polymer Networks, edited by D. Klempner, L. H. Sperling, and L. A. Utracki, Advances in Chemistry Series #239, 3-38, 1994).

Materials having co-continuous phases may be made in accordance with the present disclosure by a number of different methods. Thus, for example, the polymeric first phase material may be mechanically blended with the polymeric second phase material to achieve a co-continuous system. Examples of co-continuous morphologies achieved by blending are described, for example, in D. Bourry and B. D. Favis, “Co-Continuity and Phase Inversion in HDPE/PS Blends: The Role of Interfacial Modification,” 1995 Annual Technical Conference of the Society of Plastics Engineers ANTEC, Vol. 53, No. 2, 2001-2009 (polystyrene/polyethylene blends), and in A. Leclair and B. D. Favis, “The role of interfacial contact in immiscible binary polymer blends and its influence on mechanical properties,” Polymer, Vol. 37, No. 21, 4723-4728, 1996 (polycarbonate/polyethylene blends).

For example, if PEN and PC are extrusion blended at a ratio in the range of 70:30 to 55:45, co-continuous phases are formed and the polymers sufficiently transesterify to exhibit a single glass transition temperature (Tg) when measured by Differential Scanning Calorimetry (DSC) (See Example 2 below). Normally, the Tg of the non-birefringent component of the blend is lower than the Tg of the birefringent component, and the Tg of the non-birefringent component becomes the limiting factor for processing the film and end use applications of the film. However, in the PEN/PC blend, the non-birefringent component of the blend, PC, has a Tg even higher than the Tg of the birefringent component PEN. This provides a film with higher modulus that is more resistant to creep and warping, and this enhanced dimensional stability makes the films suitable for a wider range of end use applications. Copolymers of PEN with PET may also be used in this blend.

Co-continuous phases may also be formed in accordance with the present disclosure by first dissolving them out of supercritical fluid extractions, such as that disclosed for blends of polystyrene and poly(methyl methacrylate) in U.S. Pat. No. 4,281,084, and then allowing them to phase separate following exposure to heat and/or mechanical shear, as described by N. Mekhilef, B. D. Favis and P. J. Carreau in “Morphological Stability of Polystyrene Polyethylene Blends,” 1995 Annual Technical Conference of the Society of Plastics Engineers ANTEC, Vol. 53, No. 2, 1572-1579.

A further method of producing co-continuous phases in accordance with the present disclosure is through the creation of interpenetrating polymer networks (IPNs). Some of the more important IPNs include simultaneous IPNs, sequential IPNs, gradient IPNs, latex IPNs, thermoplastic IPNs, and semi-IPNs. These and other types of IPNs, their physical properties (e.g., phase diagrams), and methods for their preparation and characterization are described, for example, in L. H. Sperling and V. Mishra, “Current Status of Interpenetrating Polymer Networks,” Polymers for Advanced Technologies, Vol. 7, No. 4, 197-208, April 1996, and in L. H. Sperling, “Interpenetrating Polymer Networks: An Overview,” Interpenetrating Polymer Networks, edited by D. Klempner, L. H. Sperling, and L. A. Utracki, Advances in Chemistry Series #239, 3-38, 1994. Some of the major methods for preparing these systems are summarized below.

Simultaneous IPNs may be made by mixing together the respective monomers or prepolymers, plus the crosslinkers and activators, of two or more polymer networks. The respective monomers or prepolymers are then reacted simultaneously, but in a non-interfering manner. Thus, for example, one reaction may be made to proceed by way of chain polymerization kinetics, and the other reaction may be made to proceed through step polymerization kinetics.

Sequential IPNs are made by first forming an initial polymer network. Then, the monomers, crosslinkers, and activators of one or more additional networks are swollen into the initial polymer network, where they are reacted in situ to yield additional polymer networks.

Gradient IPNs are synthesized in such a manner that the overall composition or crosslink density of the IPN varies macroscopically in the material from one location to another. Such systems may be made, for example, by forming a first polymer network predominantly on one surface of a film and a second polymer network predominantly on another surface of the film, with a gradient in composition throughout the interior of the film.

Latex IPNs are made in the form of latexes (e.g., with a core and shell structure). In some variations, two or more latexes may be mixed and formed into a film, which crosslinks the polymers.

Thermoplastic IPNs are hybrids between polymer blends and IPNs that involve physical crosslinks instead of chemical crosslinks. As a result, these materials can be made to flow at elevated temperatures in a manner similar to that of thermoplastic elastomers, but are crosslinked and behave as IPNs at the temperatures of normal use.

Semi-IPNs are compositions of two or more polymers in which one or more of the polymers are crosslinked and one or more of the polymers are linear or branched.

As indicated above, co-continuity can be achieved in multicomponent systems as well as in binary systems. For example, three or more materials may be used in combination to give desired optical properties (e.g., transmission and reflectivity) and/or improved physical properties. All components may be immiscible, or two or more components may demonstrate miscibility. A number of ternary systems exhibiting co-continuity are described, for example, in L. H. Sperling, Chapter 1, “Interpenetrating Polymer Networks: An Overview,” Interpenetrating Polymer Networks, edited by D. Klempner, L. H. Sperling, and L. A. Utracki, Advances in Chemistry Series #239, 3-38, 1994.

Characteristic sizes of the phase structures, ranges of volume fraction over which co-continuity may be observed, and stability of the morphology may all be influenced by additives, such as compatibilizers, graft or block copolymers, or reactive components, such as maleic anhydride or glycidyl methacrylate. Such effects are described, for example, for blends of polystyrene and poly(ethylene terephthalate) in H. Y. Tsai and K. Min, “Reactive Blends of Functionalized Polystyrene and Polyethylene Terephthalate,” 1995 Annual Technical Conference of the Society of Plastics Engineers ANTEC, Vol. 53, No. 2, 1858-1865. Moreover, for particular systems, phase diagrams may be constructed through routine experimentation and used to produce co-continuous systems in accordance with the present disclosure.

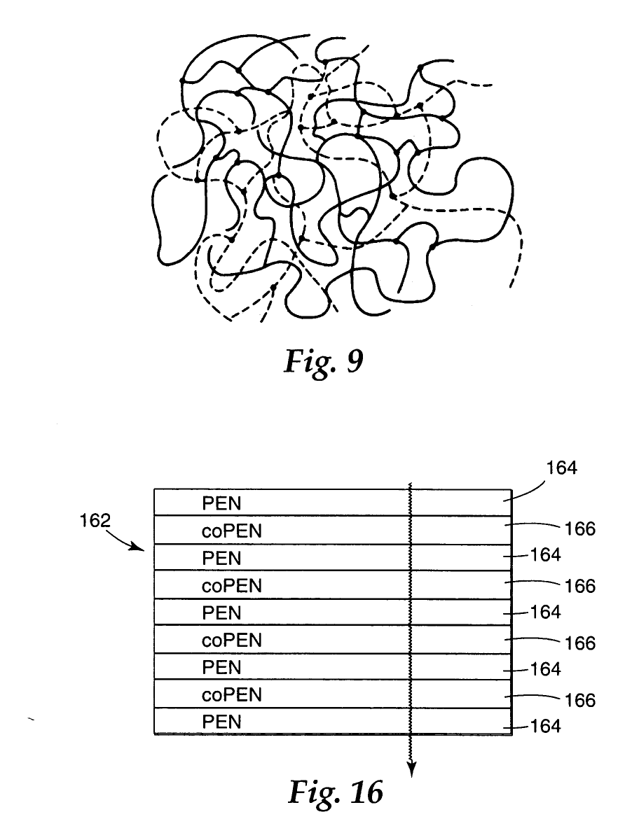

The microscopic structure of co-continuous systems made in accordance with the present disclosure can vary significantly, depending on the method of preparation, the miscibility of the phases, the presence of additives, and other factors as are known to the art. Thus, for example, one or more of the phases in the co-continuous system may be fibrillar (see, e.g., FIG. 9), with the fibers either randomly oriented or oriented along a common axis. Other co-continuous systems may comprise an open-celled matrix of a first phase, with a second phase disposed in a co-continuous manner within the cells of the matrix. The phases in these systems may be co-continuous along a single axis, along two axes, or along three axes.

Optical bodies made in accordance with the present disclosure and having co-continuous phases (particularly IPNs) will, in several instances, have properties that are advantageous over the properties of similar optical bodies that are made with only a single continuous phase, depending, of course, on the properties of the individual polymers and the method by which they are combined. Thus, for example, the co-continuous systems of the present disclosure allow for the chemical and physical combination of structurally dissimilar polymers, thereby providing a convenient route by which the properties of the optical body may be modified to meet specific needs. Furthermore, co-continuous systems will frequently be easier to process, and may impart such properties as weatherability, reduced flammability, greater impact resistance and tensile strength, improved flexibility, and superior chemical resistance. IPNs are particularly advantageous in certain applications, since they typically swell (but do not dissolve) in solvents, and exhibit suppressed creep and flow compared to analogous non-IPN systems (see, e.g., D. Klempner and L. Berkowski, “Interpenetrating Polymer Networks,” Encyclopedia of Polymer Science and Engineering, 2nd Ed., Vol. 8, 278-341).

One skilled in the art will appreciate that the principles of co-continuous systems as are known to the art may be applied in light of the teachings set forth herein to produce co-continuous morphologies having unique optical properties. Thus, for example, the refractive indices of known co-continuous morphologies may be manipulated as taught herein to produce new optical films in accordance with the present disclosure. Likewise, the principles taught herein may be applied to known optical systems to produce co-continuous morphologies.

### Size of Disperse Phase

The size of the disperse phase also can have a significant effect on scattering. If the disperse phase particles are too small (i.e., less than about 1/30 the wavelength of light in the medium of interest) and if there are many particles per cubic wavelength, the optical body behaves as a medium with an effective index of refraction somewhat between the indices of the two phases along any given axis. In such a case, very little light is scattered. If the particles are too large, the light is specularly reflected from the surface of the particle, with very little diffusion into other directions. When the particles are too large in at least two orthogonal directions, undesirable iridescence effects can also occur. Practical limits may also be reached when particles become large in that the thickness of the optical body becomes greater and desirable mechanical properties are compromised.

The dimensions of the particles of the disperse phase after alignment can vary depending on the desired use of the optical material. Thus, for example, the dimensions of the particles may vary depending on the wavelength of electromagnetic radiation that is of interest in a particular application, with different dimensions required for reflecting or transmitting visible, ultraviolet, infrared, and microwave radiation. In one embodiment, the length of the particles should be such that they are approximately greater than the wavelength of electromagnetic radiation of interest in the medium divided by 30.

Preferably, in applications where the optical body is to be used as a low loss reflective polarizer, the particles will have a length that is greater than about 2 times the wavelength of the electromagnetic radiation over the wavelength range of interest, and preferably over 4 times the wavelength. The average diameter of the particles is preferably equal to or less than the wavelength of the electromagnetic radiation over the wavelength range of interest, and preferably less than 0.5 of the desired wavelength. While the dimensions of the disperse phase are a secondary consideration in most applications, they become of greater importance in thin film applications, where there is comparatively little diffuse reflection.

### Geometry of Disperse Phase

While index mismatch is the predominant factor relied upon to promote scattering in some embodiments of the films of the present disclosure (i.e., a diffuse polarizer made in accordance with the present disclosure has a substantial mismatch in the indices of refraction of the continuous and disperse phases along one axis), the geometry of the particles of the disperse phase can have a secondary effect on scattering. Thus, the depolarization factors of the particles for the electric field in the index of refraction match and mismatch directions can reduce or enhance the amount of scattering in a given direction. For example, when the disperse phase is elliptical in a cross-section taken along a plane perpendicular to the axis of orientation, the elliptical cross-sectional shape of the disperse phase contributes to the asymmetric diffusion in both back scattered light and forward scattered light. The effect can either add or detract from the amount of scattering from the index mismatch, but generally has a small influence on scattering in the preferred range of properties in the present disclosure.

The shape of the disperse phase particles can also influence the degree of diffusion of light scattered from the particles. This shape effect is generally small but increases as the aspect ratio of the geometrical cross-section of the particle in the plane perpendicular to the direction of incidence of the light increases and as the particles get relatively larger. In general, in the operation of this disclosure, the disperse phase particles should be sized less than several wavelengths of light in one or two mutually orthogonal dimensions if diffuse, rather than specular, reflection is preferred.

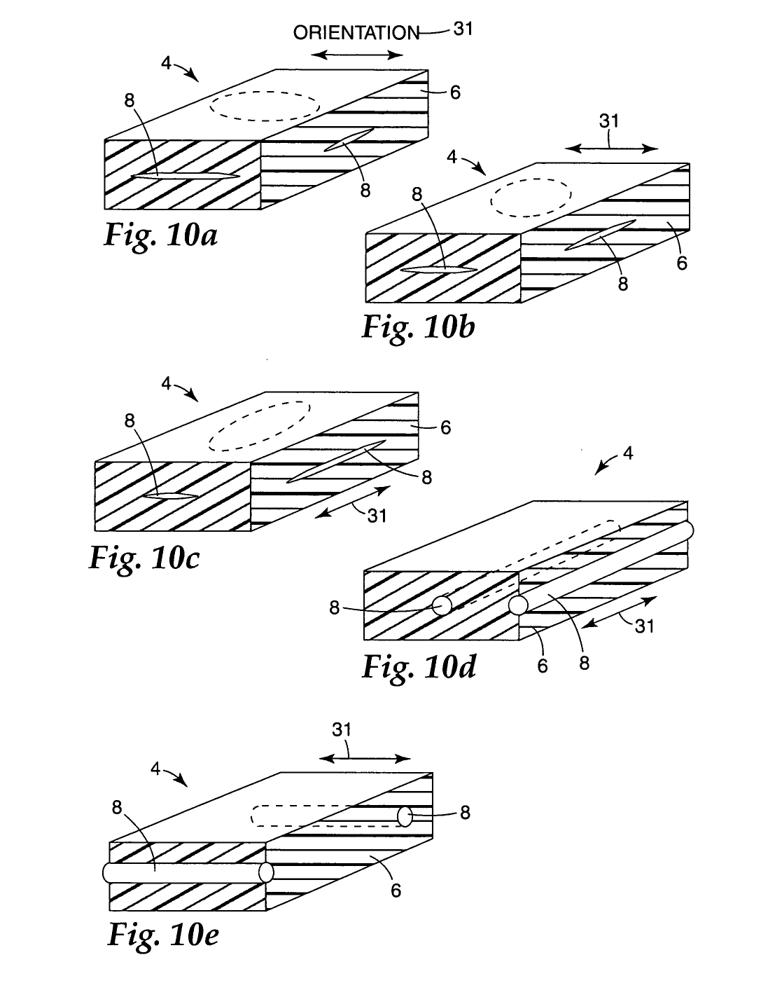

One embodiment of a low loss reflective polarizer consists of a disperse phase disposed within the continuous phase as a series of rod-like structures which, as a consequence of orientation, have a high aspect ratio which can enhance reflection for polarizations parallel to the orientation direction by increasing the scattering strength and dispersion for that polarization relative to polarizations perpendicular to the orientation direction. However, as indicated in FIGS. 10(a-e), the disperse phase 8 may be provided with many different geometries and placements with respect to orientation direction 31. Thus, the disperse phase 8 may approach the shape of disks or elongated disks, as in FIGS. 10(a-c), the shape of a rod, as in FIGS. 10(d-e), or a spherical shape, for example. Other embodiments are contemplated wherein the disperse phase 8 has cross sections that are approximately elliptical (including circular), polygonal, irregular, or a combination of one or more of these shapes. The cross-sectional shape and size of the particles of the disperse phase 8 may also vary from one particle to another, or from one region of the film 4 to another (i.e., from the surface to the core).

In some embodiments, the disperse phase 8 may have a core and shell construction, wherein the core and shell are made out of the same or different materials, or wherein the core is hollow. Thus, for example, the disperse phase 8 may consist of hollow fibers of equal or random lengths, and of uniform or non-uniform cross section. The interior space of the fibers may be empty, or may be occupied by a suitable medium which may be a solid, liquid, or gas, and may be organic or inorganic. The refractive index of the medium may be chosen in consideration of the refractive indices of the disperse phase 8 and the continuous phase 6 so as to achieve a desired optical effect (i.e., reflection or polarization along a given axis).

### Dimensional Alignment of Disperse Phase

Dimensional alignment is also found to have an effect on the scattering behavior of the disperse phase. In particular, it has been observed in optical bodies made in accordance with the present disclosure that aligned scatterers will not scatter light symmetrically about the directions of specular transmission or reflection as randomly aligned scatterers would. In particular, inclusions that have been elongated through orientation to resemble rods scatter light primarily along (or near) the surface of a cone centered on the orientation direction and along the specularly transmitted direction. This may result in an anisotropic distribution of scattered light about the specular reflection and specular transmission directions. For example, for light incident on such an elongated rod in a direction perpendicular to the orientation direction, the scattered light appears as a band of light in the plane perpendicular to the orientation direction with an intensity that decreases with increasing angle away from the specular directions. By tailoring the geometry of the inclusions, some control over the distribution of scattered light can be achieved both in the transmissive hemisphere and in the reflective hemisphere.

### Dimensions of Disperse Phase

In applications where the optical body is to be used as a low loss reflective polarizer, the structures of the disperse phase 8 preferably have a high aspect ratio, i.e., the structures are substantially larger in one dimension than in any other dimension. The aspect ratio is preferably at least 2, and more preferably at least 5. The largest dimension (i.e., the length) is preferably at least 2 times the wavelength of the electromagnetic radiation over the wavelength range of interest, and more preferably at least 4 times the desired wavelength. On the other hand, the smaller (i.e., cross-sectional) dimensions of the structures of the disperse phase are preferably less than or equal to the wavelength of interest, and more preferably less than 0.5 times the wavelength of interest.

### Thickness of Optical Body

The thickness of the optical body 4 is also an important parameter which can be manipulated to affect reflection and transmission properties in the present disclosure. As the thickness of the optical body 4 increases, diffuse reflection also increases, and transmission, both specular and diffuse, decreases. Thus, while the thickness of the optical body 4 will typically be chosen to achieve a desired degree of mechanical strength in the finished product, it can also be used to directly control reflection and transmission properties.

### Region of Spectrum

While the present disclosure is frequently described herein with reference to the visible region of the spectrum, various embodiments of the present disclosure are suited for use with other wavelengths of electromagnetic radiation through appropriate scaling of the components of the optical body 4. Thus, as the wavelength increases, the linear size of the components of the optical body 4 may be increased so that the dimensions of these components, measured in units of wavelength, remain approximately constant.

One major effect of changing wavelength is that, for most materials of interest, the index of refraction and the absorption coefficient change. However, the principles of index match and mismatch still apply at each wavelength of interest, and may be utilized in the selection of materials for an optical device that will operate over a specific region of the spectrum. Thus, for example, proper scaling of dimensions will allow operation in the infrared, near-ultraviolet, and ultra-violet regions of the spectrum. In these cases, the indices of refraction refer to the values at these wavelengths of operation, and the body thickness and size of the disperse phase scattering components should also be appropriately scaled with wavelength. Even more of the electromagnetic spectrum can be used, including very high, ultrahigh, microwave and millimeter wave frequencies. Polarizing and diffusing effects will be present with proper scaling to wavelength, and the indices of refraction can be obtained from the square root of the dielectric function (including real and imaginary parts). Useful products in these longer wavelength bands include diffuse reflective polarizers and partial polarizers.

In some embodiments of the present disclosure, the optical properties of the optical body vary across the wavelength band of interest. In these embodiments, materials may be utilized for the continuous and/or disperse phases whose indices of refraction, along one or more axes, vary from one wavelength region to another. The choice of continuous and disperse phase materials, and the optical properties (i.e., diffuse and disperse reflection or specular transmission) resulting from a specific choice of materials, will depend on the wavelength band of interest.

### Microvoiding

In some embodiments, the materials of the continuous and disperse phases may be chosen so that the interface between the two phases will be sufficiently weak to result in voiding when the film is oriented. The average dimensions of the voids may be controlled through careful manipulation of processing parameters and stretch ratios, or through selective use of compatibilizers. The voids may be back-filled in the finished product with a liquid, gas, or solid. Voiding may be used in conjunction with the aspect ratios and refractive indices of the disperse and continuous phases to produce desirable optical properties in the resulting film.

### More Than Two Phases

The optical bodies 4 made in accordance with the present disclosure may also consist of more than two phases 6, 8. Thus, for example, an optical material made in accordance with the present disclosure can consist of two different disperse phases 8 within a continuous phase 6. The second disperse phase 8 could be randomly or non-randomly dispersed throughout the continuous phase 6, and can be randomly aligned or aligned along a common axis.

Optical bodies 4 made in accordance with the present disclosure may also consist of more than one continuous phase 6. Thus, in some embodiments, the optical body 4 may include, in addition to a first continuous phase 6 and a disperse phase 8, a second phase 6 which is co-continuous in at least one dimension with the first continuous phase 6. In one particular embodiment, the second continuous phase 6 is a porous, sponge-like material which is coextensive with the first continuous phase 6 (i.e., the first continuous phase 6 extends through a network of channels or spaces extending through the second continuous phase 6, much as water extends through a network of channels in a wet sponge). In a related embodiment, the second continuous phase 6 is in the form of a dendritic structure which is coextensive in at least one dimension with the first continuous phase 6.

### Additives

The optical materials of the present disclosure may also comprise other materials or additives as are known to the art. Such materials include pigments, dyes, binders, coatings, fillers, compatibilizers, antioxidants (including sterically hindered phenols), surfactants, antimicrobial agents, antistatic agents, flame retardants, foaming agents, lubricants, reinforcers, light stabilizers (including UV stabilizers or blockers), heat stabilizers, impact modifiers, plasticizers, viscosity modifiers, and other such materials. Furthermore, the films and other optical devices made in accordance with the present disclosure may include one or more outer layers which serve to protect the device from abrasion, impact, or other damage, or which enhance the processability or durability of the device.

Suitable lubricants for use in the present disclosure include calcium sterate, zinc sterate, copper sterate, cobalt sterate, molybdenum neodocanoate, and ruthenium (III) acetylacetonate, for example.

Antioxidants useful in the present disclosure include 4,4′-thiobis-(6-t-butyl-m-cresol), 2,2′-methylenebis-(4-methyl-6-t-butyl-butylphenol), octadecyl-3,5-di-t-butyl-4-hydroxyhydrocinnamate, bis-(2,4-di-t-butylphenyl)pentaerythritol diphosphite, Irganox<< 1093 (1979)(((3,5 -bis(1,1-dimethylethyl)-4-hydroxyphenyl)methyl)-dioctadecyl ester phosphonic acid), Irganox<< 1098 (N,N′-1,6-hexanediylbis(3,5-bis(1,1-dimethyl)-4-hydroxy-benzenepropanamide), Naugaard<< 445 (aryl amine), Irganox<< L 57 (alkylated diphenylamine), Irganox<< L 115 (sulfur containing bisphenol), Irganox<< LO 6 (alkylated phenyl-delta-napthylamine), Ethanox 398 (flourophosphonite), and 2,2′-ethylidenebis(4,6-di-t-butylphenyl) fluorophosnite, for example.

A group of antioxidants that are especially suitable are sterically hindered phenols, including butylated hydroxytoluene (BHT), Vitamin E (di-alphatocopherol), Irganox<< 1425 WL(calcium bis-(O-ethyl(3,5-di-t-butyl-4-hydroxybenzyl))phosphonate), Irganox<< 1010 (tetrakis(methylene(3,5,di-t-butyl-4-hydroxyhydrocinnamate))methane), Irganox<< 1076 (octadecyl 3,5-di-tert-butyl-4-hydroxyhydrocinnamate), Ethanox<< 702 (hindered bis phenolic), Ethanox 330 (high molecular weight hindered phenolic), and Ethanox<< 703 (hindered phenolic amine), for example.

Dichroic dyes are a particularly useful additive in some applications to which the optical materials of the present disclosure may be directed, due to their ability to absorb light of a particular polarization when they are molecularly aligned within the material. When used in a film or other material which predominantly scatters only one polarization of light, the dichroic dye causes the material to absorb one polarization of light more than another. Suitable dichroic dyes for use in the present disclosure include Congo Red (sodium diphenyl-bis-\acute{α}-naphthylamine sulfonate), methylene blue, stilbene dye (Color Index (CI)=620), and 1,1′-diethyl-2,2′-cyanine chloride (CI=374 (orange) or CI=518 (blue)), for example. The properties of these dyes, and methods of making them, are described in E. H. Land, Colloid Chemistry (1946). These dyes have noticeable dichroism in polyvinyl alcohol and a lesser dichroism in cellulose. A slight dichroism is observed with Congo Red in PEN.

The properties of these dyes, and methods of making them, are discussed in the Kirk Othmer Encyclopedia of Chemical Technology, Vol. 8, pp. 652-661 (4th Ed. 1993), and in the references cited therein.

When a dichroic dye is used in the optical bodies of the present disclosure, it may be incorporated into either a continuous or a disperse phase or sometimes both into continuous and disperse phases. In an exemplary embodiment, the dichroic dye is incorporated into the disperse phase 8. In other exemplary embodiments, a dichroic dye material or another absorbing polarizer material may be disposed as one or more additional layers on one or more surfaces of the polarizing films according to the present disclosure prior to orientation, or one or more absorbing polarizer layers may be attached, e.g., laminated, to a polarizing film of the present disclosure after orientation.

Dychroic dyes in combination with certain polymer systems exhibit the ability to polarize light to varying degrees. Polyvinyl alcohol and certain dichroic dyes may be used to make films with the ability to polarize light. Other polymers, such as polyethylene terephthalate or polyamides, such as nylon-6, do not exhibit as strong an ability to polarize light when combined with a dichroic dye. The polyvinyl alcohol and dichroic dye combination is said to have a higher dichroism ratio than, for example, the same dye in other film forming polymer systems. A higher dichroism ratio indicates a higher ability to polarize light.

Molecular alignment of a dichroic dye within an optical body made in accordance with the present disclosure is accomplished in one embodiment by stretching the optical body after the dye or another absorbing polarizer material has been incorporated into it. However, other methods may also be used to achieve molecular alignment. Thus, in one method, the dichroic dye is crystallized, as through sublimation or by crystallization from solution, into a series of elongated notches that are cut, etched, or otherwise formed in the surface of a film or other optical body, either before or after the optical body has been stretched. The treated surface may then be coated with one or more surface layers, may be incorporated into a polymer matrix or used in a multilayer structure, or may be utilized as a component of another optical body. The notches may be created in accordance with a predetermined pattern or diagram, and with a predetermined amount of spacing between the notches, so as to achieve desirable optical properties.

In a related embodiment, the dichroic dye may be disposed within one or more hollow fibers or other conduits, either before or after the hollow fibers or conduits are disposed within the optical body. The hollow fibers or conduits may be constructed out of a material that is the same or different from the surrounding material of the optical body.

In yet another embodiment, the dichroic dye is disposed along the layer interface of a multilayer construction, as by sublimation onto the surface of a layer before it is incorporated into the multilayer construction. In still other embodiments, the dichroic dye is used to at least partially backfill the voids in a microvoided film made in accordance with the present disclosure.

Coloring materials, such as dyes and pigments, may also be added as desired to adjust the visual perception of color of some polarizing films. In some exemplary embodiments, an additional coloring material may be used to adjust the appearance of a complementarily-colored film. In addition, the wide range of polymers available for the disperse phase makes possible the selection of materials with more similar dispersion curves. This allows matching of refractive indices over a broader range of wavelengths, which may provide a more color-neutral polarizer.

### Effect of Index Match/Mismatch

In an exemplary embodiment, the materials of at least one of the continuous and disperse phases are of a type that undergoes a change in refractive index upon orientation. Consequently, as the film is stretched in one or more directions, refractive index matches or mismatches are produced along one or more axes. By careful manipulation of orientation parameters and other processing conditions, the positive or negative birefringence of the matrix can be used to induce diffuse reflection or transmission of one or both polarizations of light along a given axis. The relative ratio between transmission and diffuse reflection is dependent on the concentration of the disperse phase inclusions, the thickness of the film, the square of the difference in the index of refraction between the continuous and disperse phases, the size and geometry of the disperse phase inclusions, and the wavelength or wavelength band of the incident radiation.

The magnitude of the index match or mismatch along a particular axis directly affects the degree of scattering of light polarized along that axis. In general, scattering power varies as the square of the index mismatch. Thus, the larger the index mismatch along a particular axis, the stronger the scattering of light polarized along that axis. Conversely, when the mismatch along a particular axis is small, light polarized along that axis is scattered to a lesser extent and is thereby transmitted specularly through the volume of the body.

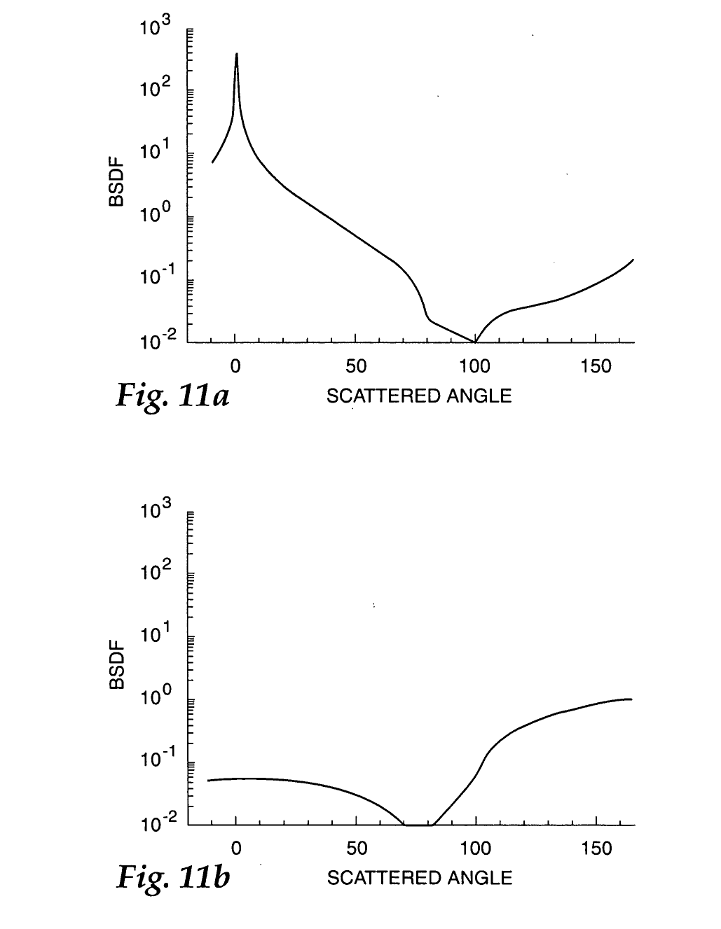

FIGS. 11(a-b) demonstrate this effect in oriented films made in accordance with the present disclosure. There, a typical Bidirectional Scatter Distribution Function (BSDF) measurement is shown for normally incident light at 632.8 nm. The BSDF is described in J. Stover, “Optical Scattering Measurement and Analysis” (1990). The BSDF is shown as a function of scattered angle for polarizations of light both perpendicular and parallel to the axis of orientation. A scattered angle of zero corresponds to unscattered (spectrally transmitted) light. For light polarized in the index match direction (that is, perpendicular to the orientation direction) as in FIG. 11(a), there is a significant specularly transmitted peak with a sizable component of diffusely transmitted light (scattering angle between 8 and 80 degrees), and a small component of diffusely reflected light (scattering angle larger than 100 degrees). For light polarized in the index mismatch direction (that is, parallel to the orientation direction) as in FIG. 11(b), there is negligible specularly transmitted light and a greatly reduced component of diffusely transmitted light, and a sizable diffusely reflected component. It should be noted that the plane of scattering shown by these graphs is the plane perpendicular to the orientation direction where most of the scattered light exists for these elongated inclusions. Scattered light contributions outside of this plane are greatly reduced.

If the index of refraction of the inclusions (i.e., the disperse phase) matches that of the continuous host media along some axis, then incident light polarized with electric fields parallel to this axis will pass through unscattered regardless of the size, shape, and density of inclusions. If the indices are not matched along some axis, then the inclusions will scatter light polarized along this axis. For scatterers of a given cross-sectional area with dimensions larger than approximately λ/30 (where λ is the wavelength of light in the media), the strength of the scattering is largely determined by the index mismatch. The exact size, shape and alignment of a mismatched inclusion play a role in determining how much light will be scattered into various directions from that inclusion. If the density and thickness of the scattering layer is sufficient, according to multiple scattering theory, incident light will be either reflected or absorbed, but not transmitted, regardless of the details of the scatterer size and shape.

### Making the Oriented Films of the Disclosure

The materials selected for use in a polarizer in accordance with the present disclosure, and the degree of orientation of these materials, are chosen in one embodiment so that the phases in the finished polarizer have at least one axis for which the associated indices of refraction are sufficiently close, and, in an exemplary embodiment, substantially equal. The match of refractive indices associated with that axis, which typically, but not necessarily, is an axis transverse to the direction of orientation, results in little or substantially no reflection of light in that plane of polarization or in scattering of light having that polarization.

The first phase may also exhibit a decrease in the refractive index associated with the direction of orientation after stretching. If the birefringence of the first or second is positive, a negative strain induced birefringence of the second or first phase, respectively, has the advantage of increasing the difference between indices of refraction of the adjoining phases associated with the orientation axis while the reflection of light with its plane of polarization perpendicular to the orientation direction is still negligible. In exemplary embodiments, differences between the indices of refraction of adjoining phases in the direction orthogonal to the orientation direction are less than about 0.05 after orientation, and preferably, less than about 0.02.

In some exemplary embodiments, the disperse phase may exhibit a positive strain induced birefringence. However, this can be altered by means of heat treatment to match the refractive index of the axis perpendicular to the orientation direction 31 of the continuous phase. In an exemplary embodiment, the temperature of the heat treatment is not so high that it relaxes the birefringence in the birefringent continuous phase.

The geometry of the disperse phase may be achieved through suitable processing, such as orientation, of the optical material; through the use of particles having a particular geometry; or through a combination of the two. Thus, for example, a disperse phase having a substantially rod-like structure can be produced by stretching a film consisting of approximately spherical disperse phase particles along a single axis. The rod-like structures can be given an approximately elliptical cross-section by stretching the film in a second direction perpendicular to the first. As a further example, a disperse phase having a substantially rod-like structure in which the rods are approximately rectangular in cross-section can be produced by stretching in a single direction a film having a disperse phase consisting of a series of essentially rectangular flakes.

Stretching is one convenient manner for arriving at a desired geometry, since stretching can also be used to induce a difference in indices of refraction within the material. As indicated above, the orientation of films in accordance with the disclosure may be in more than one direction, and may be sequential or simultaneous.

The optical bodies of the present disclosure, such as polarizing films and optical bodies, may be made by any process that provides a large difference in index of refraction between the continuous and disperse phases along a first axis in a plane parallel to the surface of the film, and a small difference in index of refraction between the continuous and disperse phases along the other two orthogonal axes.

While the batch process described in FIG. 8 may in some cases provide suitable properties, the processes described in commonly owned U.S. Pat. Nos. 6,936,209; 6,949,212; 6,939,499; and 6,916,440, referred to as uniaxial or substantially uniaxial orientation processes, are particularly suitable.

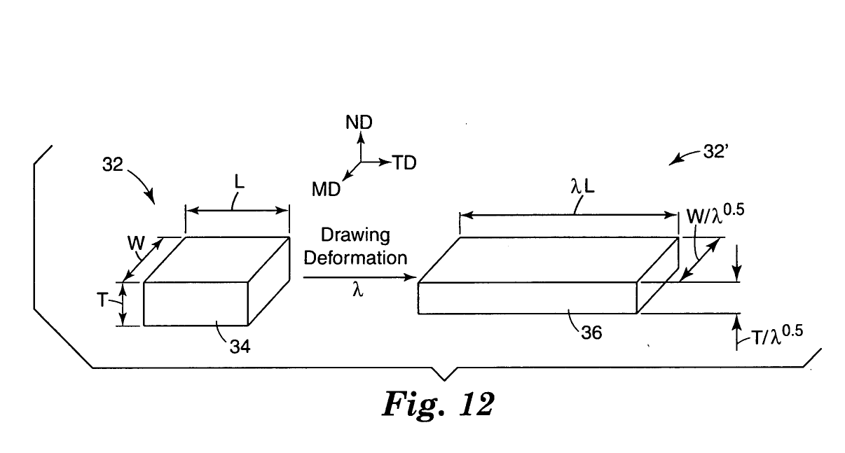

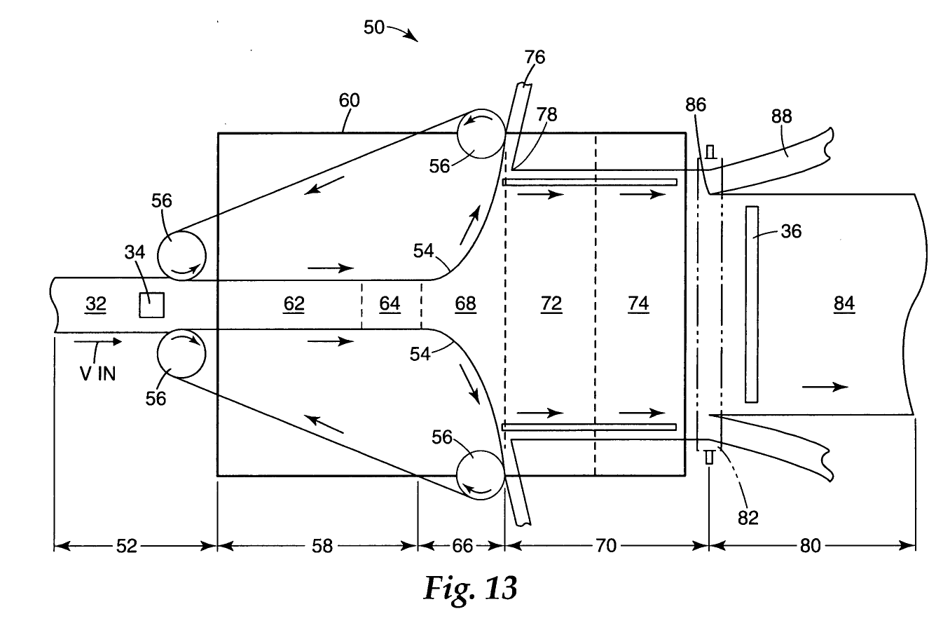

The processes of the present disclosure may include stretching an optical body that can be described with reference to three mutually orthogonal axes corresponding to the machine direction (MD), the transverse direction (TD), and the normal direction (ND). These axes correspond to the width, length, and thickness of the optical body 32 illustrated in FIG. 12. The stretching process stretches an optical body 32 from an initial configuration 34 to a final configuration 36. The machine direction (MD) is the general direction along which the film 32 travels through a stretching device, for example, the apparatus illustrated in FIG. 13. The transverse direction (TD) is the second axis within the plane of the film 32 and is orthogonal to the machine direction (MD). The normal direction (ND) is orthogonal to both MD and TD and corresponds generally to the thickness dimension of the polymer film 32.

FIG. 13 illustrates one embodiment of a stretching apparatus 50 and method of the present disclosure. The optical body 32 can be provided to the stretching apparatus 50 by any desirable method. For example, the optical body 32 can be produced in a roll or other form and then provided to stretching apparatus 50. As another example, the stretching apparatus 50 can be configured to receive the optical body 32 from an extruder (if, for example, the optical body 32 is generated by extrusion and ready for stretching after extrusion) or a coater (if, for example, the optical body 32 is generated by coating or is ready for stretching after receiving one or more coated layers) or a laminator (if, for example, the optical body 32 is generated by lamination or is ready for stretching after receiving one or more laminated layers).

Generally, an optical body 32 is presented in region 52 to one or more gripping members that are configured and arranged to hold opposing edges of the optical body 32 and convey the optical body 32 along opposing tracks 54 defining predetermined paths. The gripping members (not shown) typically hold the optical body 32 at or near its edges. The portions of the optical body 32 held by the gripping members are often unsuitable for use after stretching so the position of the gripping members is typically selected to provide sufficient grip on the film 32 to permit stretching while controlling the amount of waste material generated by the process.

Gripping members, such as clips, can be directed along the track 54 by, for example, rollers 56 rotating a chain along the track 54 with the gripping members coupled to the chain. The rollers 56 are connected to a driver mechanism that controls the speed and direction of the film 32 as it is conveyed through the stretching apparatus 50. Rollers 56 can also be used to rotate and control the speed of belt-type gripping members.

The apparatus 50 optionally includes a preconditioning region 58 that typically is enclosed by an oven 60 or other apparatus or arrangement to heat the optical body 32 in preparation for stretching. The preconditioning region 58 can include a preheating zone 62, a heat soak zone 64, or both.

In one embodiment, the optical film 32 is stretched in the primary stretching region 66. Typically, within the primary stretching region 66 the optical body 32 is heated or maintained in a heated environment above the glass transition of the polymer(s) of the optical body 32. Within the primary stretching region 66, the gripping members follow generally diverging tracks 54 to stretch the optical body 32 by a desired amount. The tracks 54 in the primary stretching region 66 and in other regions of the apparatus can be formed using a variety of structures and materials. Outside of the primary stretching region 66, the tracks 54 are typically substantially linear. The opposing linear tracks 54 can be parallel or can be arranged to be converging or diverging. Within the primary stretching region 66, the tracks 54 are generally diverging and preferably curvilinear or formed from linear segments that approximate a curvilinear track shape.

In all regions of the stretching apparatus 50, the tracks 54 can be formed using a series of linear or curvilinear segments that are optionally coupled together. As an alternative or in particular regions or groups of regions, the tracks 54 can be formed as a single continuous construction. In at least some embodiments, the tracks 54 in the primary stretching region 66 are coupled to, but separable from, the tracks 54 of the preceding regions 52, 58. In some embodiments, the tracks in the succeeding post-conditioning or removal regions 70, 80 are typically separated from the tracks 54 of the primary stretching region 66. In some embodiments, the positions of one or more, and preferably all, of the track segments are adjustable (e.g., pivotable about an axis) so that the overall shape of the tracks 54 can be adjusted if desired. Continuous tracks 54 can also be used through each of the regions. In such exemplary embodiments, the overall shape of the tracks 54 also can be adjusted, if desired, using one or more track shape controllers coupled to each track in the primary stretching region.

In one example, the apparatus 50 typically includes a post-conditioning region 70. For example, the film 32 may be heat set in zone 72 and quenched in zone 50. In some other embodiments, quenching is performed outside the stretching apparatus 50.

In some embodiments, the portions of the optical body 32 that were held by the gripping members through the primary stretching region 66 are removed. In one embodiment, to maintain a substantially uniaxial stretch throughout substantially all of the stretch history, at the end of the transverse stretch, the rapidly diverging edge portions 76 are severed from the stretched optical body 68 at a slitting point 78. A cut can be made at point 78 and flash or unusable portions 76 can be discarded.

Release of the selvages 76 from a continuous gripping mechanism can be done continuously; however, release from discrete gripping mechanisms, such as tenter clips, should preferably be done so that all the material under any given clip is released at once. Discrete release mechanisms may cause larger upsets in stress that may be felt by the stretching web upstream. In order to assist the action of the isolating takeaway device, it is preferred in one embodiment to use a continuous selvage separation mechanism in the device, such as, for example, the “hot” slitting of the selvage 76 from the central portion of a heated, stretched film.

In one embodiment, the slitting location 78 is preferably located near enough to the “gripline,” e.g. the isolating takeaway point of first effective contact by the gripping members of the take-away system 150, to minimize or reduce stress upsets upstream of that point. If the film is slit before the film is gripped by the take-away system 150, instable takeaway can result, for example, by film “snapback” along TD. The film is thus preferably slit at or downstream of the gripline. Slitting is a fracture process and, as such, typically has a small but natural variation in spatial location. Thus, it may be preferred to slit slightly downstream of the gripline to prevent any temporal variations in slitting from occurring upstream of the gripline. If the film is slit substantially downstream from the gripline, the film between the takeaway and boundary trajectory will continue to stretch along TD. Since only this portion of the film is now stretching, it now stretches at an amplified draw ratio relative to the boundary trajectory, creating further stress upsets that could propagate upstream, for example, undesirable levels of machine direction tension propagating upstream.

The slitting is preferably mobile and re-positionable so that it can vary with the changes in takeaway positions needed to accommodate variable final transverse stretch direction ratio or adjustment of the position of the take-away system. An advantage of this type of slitting system is that the draw ratio can be adjusted while maintaining the stretch profile simply by moving the take-away slitting point 78. A variety of slitting techniques can be used including a heat razor, a hot wire, a laser, a focused beam of intense infrared (IR) radiation or a focused jet of heated air, for example.

In some embodiments using an angled take-away system 150, the two opposing tracks 152, 154 are positioned to receive film 32 having the same or substantially similar TDDR (where the dotted line 160 indicates film 32 at the same TDDR), as illustrated in FIG. 25. In other embodiments, the two opposing tracks 152, 154 are positioned to receive the film 32 so that the TDDR is different for the two opposing tracks 152, 154 (the dotted line 160 of FIG. 26 indicates film 32 at the same TDDR), as illustrated in FIG. 26. This latter configuration can provide a film 32 with properties that change over the TD dimension of the film 32.

The apparatus shown in FIG. 13 may optionally include a post-conditioning region 70. For example, the optical body 32 may be set in zone 72 and quenched in zone 74. A takeaway system may be used to remove the optical body 32 from the primary stretching region 66. The takeaway system can use any film conveyance structures such as tracks with gripping members such as, for example, opposing sets of belts or tenter clips.

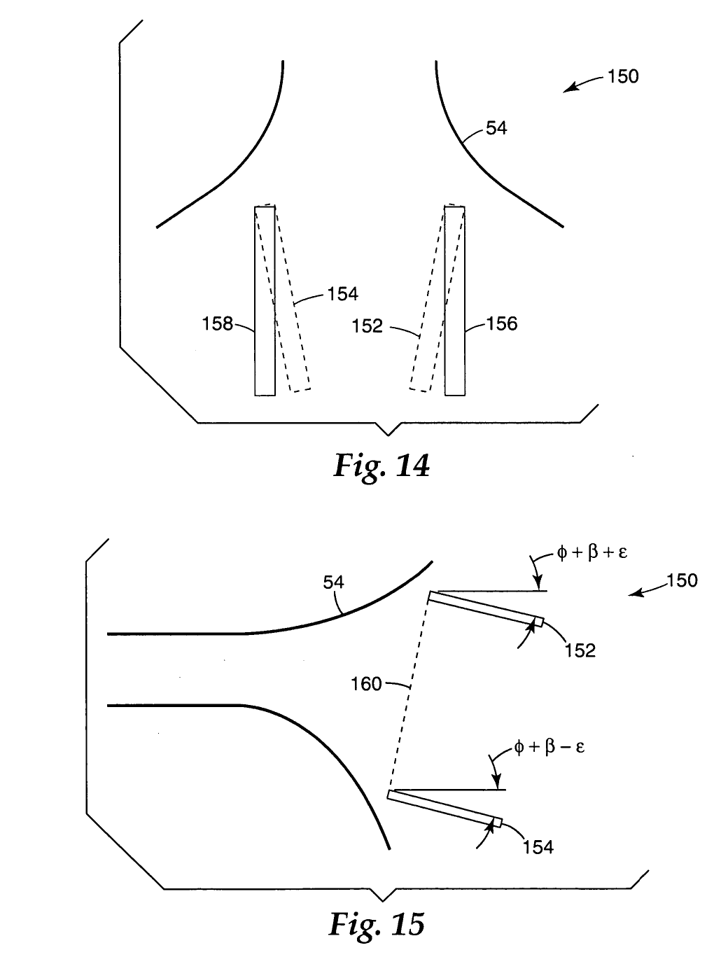

FIG. 14 is a schematic illustration of one embodiment of a take-away system 150 for a stretching apparatus according to the present disclosure. In some embodiments, TD shrinkage control can be accomplished using tracks 152, 154 that are angled with respect to each other (as compared to parallel tracks 156, 158). For example, the tracks 152, 154 of the take-away system 150 can be positioned to follow a slowly converging path (in one embodiment making an angle θ of no more than about 5°) through at least a portion of the post conditioning region 70 to allow for TD shrinkage of the film 32 with cooling. In other embodiments, the two opposing tracks 152, 154 can be diverging typically at an angle of no more than about 3° although wider angles can be used in some embodiments. This can be useful to increase the MD tension of the film 32 in the primary stretching region 66 to, for example, reduce property non-uniformity such as the variation of principal axes of refractive index across the film 32.

In some exemplary embodiments, the centerline of the take-away system is angled with respect to the centerline of the film as the film is conveyed through the tracks 54 of the primary stretching region 66.

FIG. 15 is a schematic illustration of an angled take-away system 150 for a stretching apparatus. An angled take-away system 150, primary stretching zone 66, or both can be useful to provide films where the principal axis or axes of an property of the film 32, such as the refractive index axes or tear axis, is angled with respect to the film 32. In some embodiments, the angle that the take-away system makes with respect to the primary stretching zone 66 is adjustable manually or mechanically using a computer-controlled driver or other control mechanism or both.

The exemplary process of FIG. 13 also includes a removal portion in region 80. Optionally a roller 82 is used to advance the film 32, but this element may be omitted. In one embodiment, another cut 86 may be made and unused portion 88 may be discarded. Film 32 leaving the take-away system 150 is typically wound on rolls for later use. In another embodiment, direct converting to a final product may take place after take away.

Referring back to FIG. 12, the paths defined by the opposing tracks affect the stretching of the film in the MD, TD, and ND directions. The stretching transformation can be described as a set of draw ratios: the machine direction draw ratio (MDDR), the transverse direction draw ratio (TDDR), and the normal direction draw ratio (NDDR). When determined with respect to the film, the particular draw ratio is generally defined as the ratio of the current size (for example, length, width, or thickness) of the film in a desired direction (for example, TD, MD, or ND) and the initial size (for example, length, width, or thickness) of the film in that same direction. At any given point in the stretching process, TDDR corresponds to a ratio of the current separation distance of the boundary trajectories, L, and the initial separation distance of the boundary trajectories, L₀, at the start of the stretch. In other words, TDDR=L/L₀=λ. Some useful values of TDDR include about 1.5 to about 7 or more. Exemplary useful values of TDDR include about 2, 4, 5 and 6. Other exemplary useful values of TDDR lie in the ranges of about 4 to about 20, about 4 to about 12, about 4 to about 8 and about 12 to about 20.

As explained in U.S. Pat. Nos. 6,939,499; 6,916,440; 6,949,212; and 6,936,209, substantially uniaxial stretching conditions, with an increase in dimension in the transverse direction, result in TDDR, MDDR, and NDDR approaching λ, (λ)^{-1/2}, and (λ)^{-1/2}, respectively, assuming constant density of the material. A perfectly uniaxially oriented film is one in which MDDR=(NDDR)−½=(TDDR)−½ throughout the stretch.

A useful measure of the extent of uniaxial character, U, can be defined as:

$$U = \frac{\frac{1}{MDDR} - 1}{{TDDR}^{1 / 2} - 1}$$

For a perfect uniaxial stretch, U is one throughout the stretch. When U is less than one, the stretching condition is considered “subuniaxial.” When U is greater than one, the stretching condition is considered “super-uniaxial.” States of U greater than unity represent various levels of over-relaxing. These over-relaxed states produce MD compression from the boundary edge. U can be corrected for changes in density to give U_{f} according to the following formula:

$${U}_{f} = \frac{\frac{1}{MDDR} - 1}{{( \frac{TDDR}{{ρ}_{f}} )}^{1 / 2} - 1}$$

Where ρ_{f}=ρ₀/ρ with ρ being the film material density at the present point in the stretching and ρ₀ being the film material initial density at the start of the stretch.

In some exemplary embodiments, the film is stretched in plane (i.e., the boundary trajectories and tracks are coplanar) such as shown in FIG. 13, but non-coplanar stretching trajectories are also within the scope of the present disclosure. With in-plane boundary trajectories, one result for a perfect uniaxial orientation is a pair of mirror symmetric, in-plane, parabolic trajectories diverging away from the in-plane MD centerline.

Uniaxial stretch may be maintained along the entire history of the stretch as long as the speed of the central point reduces at every point along the central trace from its initial speed by a factor of the square root of the reciprocal of the instantaneous TDDR measured between the corresponding opposing points on the opposing boundary trajectories.

Various factors can affect the ability to achieve uniaxial orientation including, for example, non-uniform thickness of the polymer film, non-uniform heating of the polymer film during stretching, and the application of additional tension (for example, machine direction tension) from, for example, down-web regions of the apparatus. However, in many instances it is not necessary to achieve perfect uniaxial orientation. In some exemplary implementations of the present disclosure, any value of U>0 may be useful. Thus, a minimum or threshold U value or an average U value that is maintained throughout the stretch or during a particular portion of the stretch can be defined. For example, in some exemplary embodiments, an acceptable minimum/threshold or average U value can be 0.2, 0.5, 0.7, 0.75, 0.8, 0.85, 0.9, or 0.95, as desired, or as needed for a particular application. When a specific value of U is chosen, the equations above provide a specific relationship between MDDR and TDDR, which, when coupled with other relevant considerations, specify a broader class of boundary trajectories that also include the parabolic trajectories for U approaching unity. Trajectories that exhibit values of U below unity for at least a final portion of the stretch are referred to herein as sub-parabolic trajectories.

The classes of trajectories described above are illustrative and should not be construed as limiting. A host of trajectory classes are considered to lie within the scope of the present invention. The primary stretching region 66 can contain two or more different zones with different stretching conditions. For example, one trajectory from a first class of trajectories can be selected for an initial stretching zone and another trajectory from the same first class of trajectories or from a different class of trajectories can be selected for each of the subsequent stretching zones.

Exemplary embodiments of the present disclosure encompass boundary trajectories comprising a minimum value of U>0. The present disclosure includes substantially uniaxial boundary trajectories comprising a minimum value of U of about 0.2, preferably about 0.5, more preferably about 0.7, even more preferably about 0.75, still more preferably about 0.8 and even more preferably about 0.85. The minimum U constraint may be applied over a final portion of the stretch defined by a critical TDDR preferably of about 2.5, still more preferably about 2.0 and more preferably about 1.5. In some embodiments, the critical TDDR may be about 4, 5 or more. Above a critical TDDR, certain materials, e.g. certain monolithic and multilayer films comprising orientable and birefringent polyesters, may begin to lose their elasticity or capability of snap back, for example, because of the development of structure such as strain-induced crystallinity.

As an example of acceptable substantially uniaxial applications, the off-angle characteristics of reflective polarizers are strongly impacted by the difference in the MD and ND indices of refraction when TD is the principal mono-axial stretch direction. An index difference in MD and ND of 0.08 is acceptable in some applications. A difference of 0.04 is acceptable in others. In more stringent applications, a difference of 0.02 or less is preferred. For example, the extent of uniaxial character of 0.85 is sufficient in many cases to provide an index of refraction difference between the MD and ND directions in polyester systems containing polyethylene naphthalate (PEN) or copolymers of PEN of 0.02 or less at 633 nm for mono-axially transverse stretched films. For some polyester systems, such as polyethylene terephthalate (PET), a lower U value of 0.80 or even 0.75 may be acceptable because of lower intrinsic differences in refractive indices in non-substantially uniaxially stretched films.

For sub-uniaxial stretches, the final extent of truly uniaxial character can be used to estimate the level of refractive index matching between the y (MD) and z (ND) directions by the equation
Δn_{yz}=Δn_{yz}(U=0)×(1−U)
where Δn_{yz} is the difference between the refractive index in the MD direction (i.e., y-direction) and the ND direction (i.e., z-direction) for a value U and Δn_{yz}(U=0) is that refractive index difference in a film stretched identically except that MDDR is held at unity throughout the stretch. This relationship has been found to be reasonably predictive for polyester systems (including PEN, PET, and copolymers of PEN or PET) used in a variety of optical films. In these polyester systems, Δn_{yz}(U=0) is typically about one-half or more of the difference Δn_{xy}(U=0), which is the refractive difference between the two in-plane directions MD (y-axis) and TD (x-axis). Typical values for Δn_{xy}(U=O) range up to about 0.26 at 633 nm. Typical values for Δn_{yz}(U=0) range up to about 0.15 at 633 nm. For example, a 90/10 coPEN, i.e. a copolyester comprising about 90% PEN-like repeat units and 10% PET-like repeat units, has a typical value at high extension of about 0.14 at 633 nm. Films comprising this 90/10 coPEN with values of U of 0.75, 0.88 and 0.97 as measured by actual film draw ratios with corresponding values of Δn_{yz} of 0.02, 0.01 and 0.003 at 633 nm have been made according to the methods of the present disclosure.

A variety of other boundary trajectories are available when U is subuniaxial at the end of the stretching period. In particular, useful boundary trajectories include coplanar trajectories where TDDR is at least 5, U is at least 0.7 over a final portion of the stretch after achieving a TDDR of 2.5, and U is less than 1 at the end of the stretch. Other useful trajectories include coplanar and non-coplanar trajectories where TDDR is at least 7, U is at least 0.7 over a final portion of the stretch after achieving a TDDR of 2.5, and U is less than 1 at the end of the stretch. Useful trajectories also include coplanar and non-coplanar trajectories where TDDR is at least 6.5, U is at least 0.8 over a final portion of the stretch after achieving a TDDR of 2.5, and U is less than 1 at the end of the stretch. Useful trajectories include coplanar and non-coplanar trajectories where TDDR is at least 6, U is at least 0.9 over a final portion of the stretch after achieving a TDDR of 2.5, and U is less than 1 at the end of the stretch. Useful trajectories also include coplanar and non-coplanar trajectories where TDDR is at least 7 and U is at least 0.85 over a final portion of the stretch after achieving a TDDR of 2.5.

Generally, various methods may be used for forming and processing optical bodies of the present disclosure, which may include extrusion blending, coextrusion, film casting and quenching, lamination and orientation, such as uniaxial and biaxial (balanced or unbalanced) stretching. As stated above, the optical bodies can take on various configurations, and thus the methods vary depending upon the configuration and the desired properties of the final optical body.

FIG. 12 helps illustrate what is meant in this application when it is said that the process “creates substantially the same proportional dimensional changes in the second in-plane axis of the film and in the thickness direction of the film”. Three dimensional element 34 represents an unstretched portion of film (see e.g. FIGS. 12-13) with dimensions T, W and L. Three dimensional element 36 represents element 34 after it has been stretched by a length lambda. As can be seen in FIG. 12, the thickness and width have been reduced by the same proportional dimensional changes. FIG. 12 represents a uniaxial stretch, as opposed, for example, to the non-uniaxial stretch shown in FIG. 4.

As mentioned above, the present disclosure is not limited to perfect uniaxial stretching. Instead, the present disclosure includes processes, apparatuses and films that are “substantially” uniaxially stretched or that approach uniaxial stretching to a certain degree. The following discussion and observations are provided to define what is within the scope of the present disclosure.

“Substantially” uniaxially stretched films preferably possess fiber symmetry in which the properties in MD and ND are similar within a given material layer (as films comprising multiple layers may not themselves possess fiber symmetry due to the layered natured of the film composite). This may exist in an elastic material when two of the draw ratios are equal. When one of the directions, e.g. TD, is stretched, then the other two directions, e.g. MD and ND, preferably have equal draw ratios. Assuming volume conservation, the MDDR and NDDR both should approach the square root of the reciprocal of the TDDR. Films stretched in a conventional tenter are not substantially uniaxially stretched even though they have been physically stretched in only one direction (so-called “monoaxial” stretching) because the boundary constraints of the process impart differences between MDDR and NDDR.

The present disclosure is also not limited to those processes that stretch film under uniaxial conditions throughout the entire history of the stretch. In a preferred embodiment, the present disclosure addresses the inadequacy of prior art processes (e.g. the disk orienters) to provide the substantially uniaxial constraint on machine direction draw ratio (MDDR) and transverse direction draw ratio (TDDR) throughout the entire history of the stretch. The failure of the prior art to provide the uniaxial condition throughout the stretch is a cause of wrinkling and other out-of-plane defects in the final film.

In an exemplary embodiment, the present disclosure provides a process in which a substantially uniaxial stretch is provided via the boundary trajectories throughout the stretching step. More preferably, the process provides this history dependence while maintaining the film in-plane. However, the stretching step need not be performed within a substantially planar region (as depicted in FIG. 13). It is within the present disclosure to provide a boundary trajectory of the film that is three-dimensional and substantially non-planar.

Preferably the present disclosure maintains the deviation from a uniaxial stretch within certain tolerances throughout the various portions of the stretching step. Optionally, the present disclosure may maintain these conditions while deforming a portion of the film out-of-plane in an initial portion of the stretch, but return the film in-plane during a final portion of the stretch.

A variety of optical films may be stretched according to the present disclosure. The films may comprise single layer films or the multi-layer films described below.

### Multilayer Combinations

If desired, one or more sheets of a continuous/disperse phase film made in accordance with the present disclosure may be used in combination with, or as a component in, a multilayered film (for example, to increase reflectivity). Suitable multilayered films include those of the type described in WO 95/17303 (Ouderkirk et al.). In such a construction, the individual sheets may be laminated or otherwise adhered together or may be spaced apart. If the optical thicknesses of the phases within the sheets are substantially equal (that is, if each of multiple sheets presents a substantially equal and large number of scatterers to incident light along a given axis), the composite will reflect, at somewhat greater efficiency, substantially the same band width and spectral range of reflectivity (i.e., “band”) as the individual sheets. If the optical thicknesses of phases within the sheets are not substantially equal, the composite will reflect across a broader band width than the individual phases. A composite combining mirror sheets with polarizer sheets is useful for increasing total reflectance while still polarizing transmitted light. Alternatively, a single sheet may be asymmetrically and biaxially oriented to produce a film having selective reflective and polarizing properties.

FIG. 16 illustrates one example of this embodiment of the present disclosure. Here, the optical body includes a multilayer film 162 in which the layers alternate between layers of PEN 164 and layers of co-PEN 166. Each PEN layer 164 includes a suitable disperse phase 8 of a non-birefringent polymer such as, for example, polycarbonate (PC), within a matrix 6 of PEN. This type of construction is desirable in that it promotes lower off-angle color. Furthermore, since the layering or inclusion of scatterers averages out light leakage, control over layer thickness is less critical, allowing the film 162 to be more tolerable of variations in processing parameters.

Any of the materials previously noted may be used as any of the layers 164, 166 in this embodiment, or as the continuous 6 or disperse 8 phase within a particular layer 164, 166. However, PEN and co-PEN are particularly desirable as the major components of adjacent layers 164, 166, since these materials promote good laminar adhesion.

Also, a number of variations are possible in the arrangement of the layers 164, 166. Thus, for example, the layers 164, 166 can be made to follow a repeating sequence through part or all of the structure 162. One example of this is a construction having the layer pattern . . . ABCABC . . . , wherein A, B, and C are distinct materials or distinct blends or mixtures of the same or different materials, and wherein one or more of A, B, or C contains at least one disperse phase 8 and at least one continuous phase 6.

### Skin Layers

A protective layer of material which in some exemplary embodiments may be substantially free of a disperse phase may be coextensively disposed on one or both major surfaces of a single layer construction, i.e., the extruded blend of the disperse phase and the continuous phase, or a multilayer construction of alternating layers such as shown in FIG. 16. The composition of the protective layer, also sometimes called a skin layer, may be chosen, for example, to protect the integrity of the disperse phase within the extruded blend, to add mechanical or physical properties to the final film or to add optical functionality to the final film. Suitable materials of choice may include the material of the continuous phase or the material of the disperse phase. Other materials with a melt viscosity similar to the extruded blend may also be useful.

A skin layer or layers may reduce the wide range of shear intensities the extruded blend might experience within the extrusion process, particularly at the die. A high shear environment may cause undesirable surface voiding and may result in a textured surface. A broad range of shear values throughout the thickness of the film may also prevent the disperse phase from forming the desired particle size in the blend.

A skin layer or layers may also add physical strength to the resulting composite or reduce problems during processing, such as, for example, reducing the tendency for the film to split during the orientation process. Skin layer materials which remain amorphous may tend to make films with a higher toughness, while skin layer materials which are semicrystalline may tend to make films with a higher tensile modulus. Other functional components such as antistatic additives, UV absorbers, dyes, antioxidants, and pigments, may be added to the skin layer, provided they do not substantially interfere with the desired optical properties of the resulting product.

In an exemplary embodiment, the skin layers are applied to one or two sides of the extruded blend at some point during the extrusion process, such as before the extruded blend and skin layer(s) exit the extrusion die. This may be accomplished using conventional coextrusion technology, which may include using a three-layer coextrusion die. Lamination of skin layer(s) to a previously formed film of an extruded blend is also possible. Total skin layer thicknesses may range from about 2% to about 50% of the total blend/skin layer thickness.

A wide range of polymers are suitable for skin layers. Predominantly amorphous polymers include copolyesters based on one or more of terephthalic acid, 2,6-naphthalene dicarboxylic acid, isophthalic acid phthalic acid, or their alkyl ester counterparts, and alkylene diols, such as ethylene glycol. Examples of semicrystalline polymers are 2,6-polyethylene naphthalate, polyethylene terephthalate, and nylon materials.

### Antireflection Layers

The films and other optical devices made in accordance with the disclosure may also include one or more anti-reflective layers. Such layers, which may or may not be polarization sensitive, serve to increase transmission and to reduce reflective glare. An anti-reflective layer may be imparted to the films and optical devices of the present disclosure through appropriate surface treatment, such as coating or sputter etching.

In some embodiments of the present disclosure, it is desired to maximize the transmission and/or minimize the specular reflection for certain polarizations of light. In these embodiments, the optical body may comprise two or more layers in which at least one layer comprises an anti-reflection system in close contact with a layer providing the continuous and disperse phases. Such an anti-reflection system acts to reduce the specular reflection of the incident light and to increase the amount of incident light that enters the portion of the body comprising the continuous and disperse layers. Such a function can be accomplished by a variety of means well known in the art. Examples are quarter wave anti-reflection layers, two or more layer anti-reflective stacks, graded index layers, and graded density layers. Such anti-reflection functions can also be used on the transmitted light side of the body to increase transmitted light if desired.

### Applications of Present Disclosure

The optical bodies of the present disclosure are particularly useful as diffuse reflective polarizers. The reflective polarizers are particularly useful in liquid crystal display panels.

### EXAMPLES

The disclosure will now be described with reference to the following non-limiting examples.

### Example 1

A variety of birefringent and non-birefringent materials were cast as monolayer films and subsequently uniaxially oriented by the processes described in commonly owned U.S. Pat. Nos. 6,936,209; 6,949,212; 6,939,499; and 6,916,440, and shown herein in FIG. 13. The refractive indicies of the samples were measured and placed in Table 1 below.

TABLE 1

| | TD | MD | ZD |
|---|---|---|---|
| Birefringent | | | |
| Materials | | | |
| PEN | 1.85 | 1.58 | 1.577 |
| LmPEN | 1.83 | 1.573 | 1.57 |
| CoPEN 80/20 | 1.82 | 1.563 | 1.56 |
| CoPEN 78/22 | ˜1.81 | ˜1.556 | ˜1.556 |
| CoPEN 30/70 | 1.77 | 1.548 | 1.545 |
| PET | 1.715 | 1.533 | 1.532 |
| Non Birefringent | | | |
| Materials | | | |
| PS-PMMA (50% | 1.535 | 1.535 | 1.535 |
| acrylate) | | | |
| ABS-PMMA | 1.53 | 1.53 | 1.53 |
| PS-PMMA (30% | 1.56 | 1.56 | 1.56 |
| acryalte) | | | |
| PS-PMMA (20% | 1.57 | 1.57 | 1.57 |
| acrylate) | | | |
| Xylex 7200 | 1.556 | 1.556 | 1.556 |
| Eastman SA 115 | 1.57 | 1.57 | 1.57 |
| Dylark 332 | 1.58 | 1.58 | 1.58 |
| Makroblend | 1.58 | 1.58 | 1.58 |
| SAN | 1.56 | 1.56 | 1.56 |
| Polycarbonate | 1.58 | 1.58 | 1.58 |

Birefringent and non-birefringent material combinations were selected for blending with the goal of matching refractive indices in the non-primary orientation, where upon orientation of these blends diffuse reflective polarizers were produced. The refractive indices of the oriented materials with a Lambda 19 instrument.

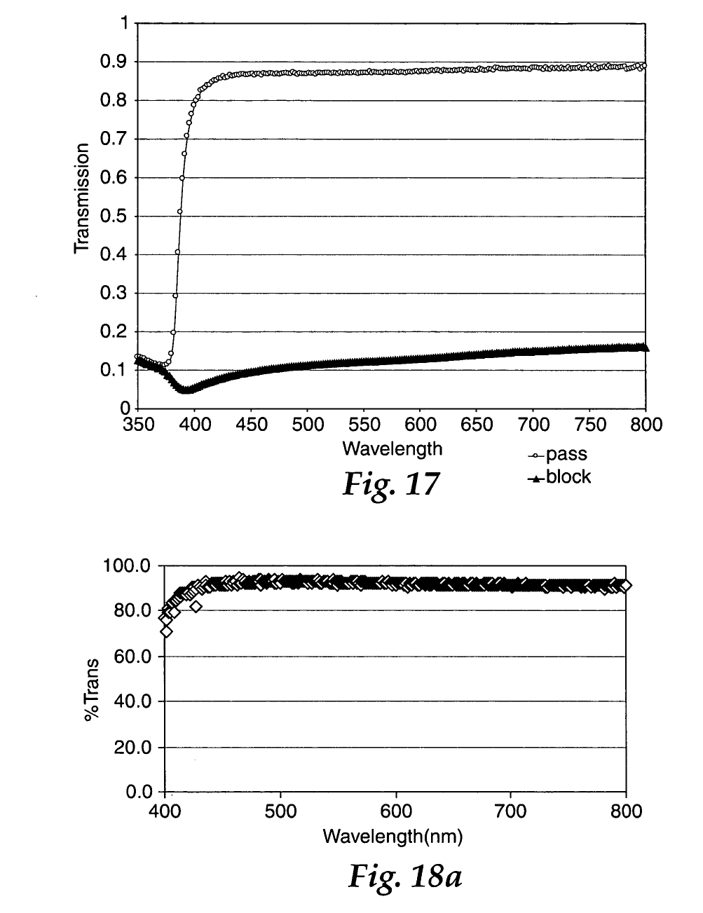

FIG. 17 displays the pass and block spectra for a PEN:SAN blend at a ratio of 55:45 and uniaxially oriented at about 1×5.

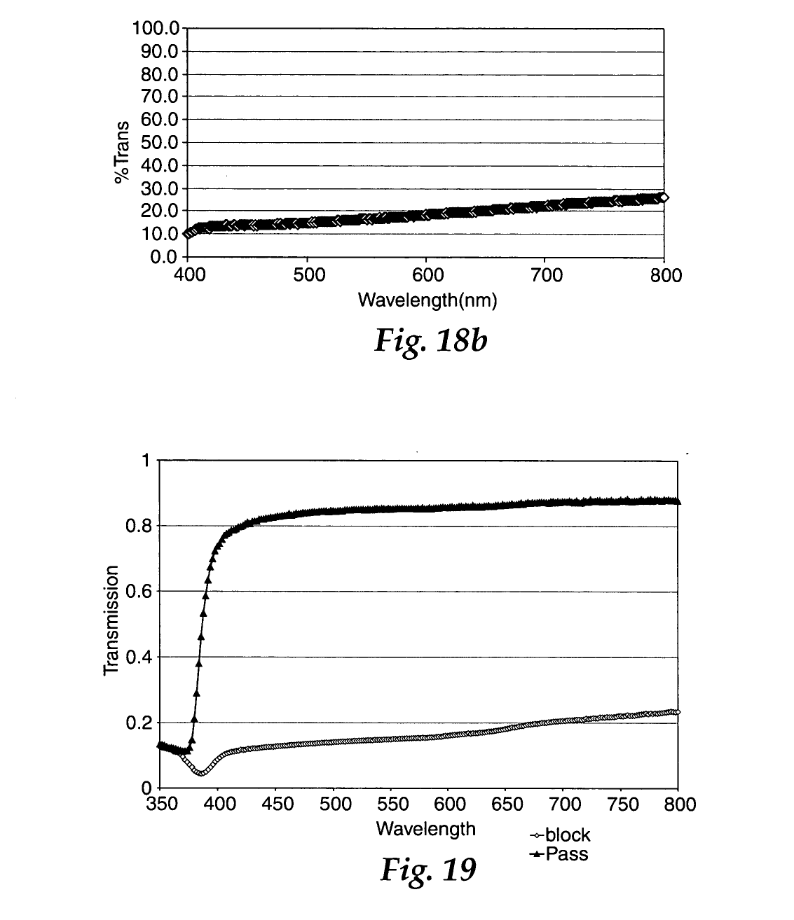

FIGS. 18a and 18b display the pass and block state spectra, respectively, for a uniaxially oriented film made of a blend of Lm PEN (90% PEN:10% PET) at a 50:50 ratio with SA 115. The resulting polarizer had a measured gain of 1.47.

The optical gain of a film is the ratio of light transmitted through a LCD panel from a backlight with the film inserted between the two to the light transmitted without the film in place.

FIG. 19 displays the pass and block spectra for a film made of a 55:45 ratio of 80%PEN/20%PET: Xylex 7200, where the film was uniaxially oriented at about 1×6.

### Example 2

Diffuse reflective polarizers were made from blends of PEN and polycarbonate (PC) extrusion blended in various ratios as shown in Table 2 using a 25 mm twin screw extruder and formed into a 20 ml thick cast web using an extrusion die. The blends were then oriented using a true uniax batch orientation process at the conditions shown in Table 2. Samples 1, 2, 4, 6, 8, and 9 were oriented in the same machine direction 14 as they were extruded and cast.

TABLE 2

| | | | Blend | Orientation | Orientation | | Draw |
|---|---|---|---|---|---|---|---|
| Example | First | Second | Ratio of | Preheat | Preheat | Draw | Rate |
| #1 | Polymer | Polymer | Polymers | Temp-C. | Time(s) | Ratio | (%/s) |
| 1 | PEN | PC | 60:40 | 155 | 50 | 5:1MD | 100 |
| 2 | PEN | PC | 55:45 | 155 | 50 | 6:1MD | 100 |
| 3 | PEN | PC | 60:40 | 155 | 50 | 6.1TD | 100 |
| 4 | PEN | PC | 60:40 | 155 | 50 | 6:1MD | 100 |
| 5 | PEN | PC | 65:35 | 155 | 50 | 6:1TD | 100 |
| 6 | PEN | PC | 65:35 | 155 | 50 | 6:1MD | 100 |
| 7 | PEN | PC | 70:30 | 155 | 50 | 6:1MD | 100 |
| 8 | PEN | PC | 70:30 | 155 | 50 | 6:1MD | 100 |
| 9 | LmPEN | SA 115 | 70:30 | 155 | 50 | 6:1MD | 100 |

Optical analysis of the samples indicated that the disperse phase (PC) had a cylindrical shape with a high aspect ratio. Comparing the optical properties of sample 4 20 to 3, sample 6 to 5, and sample 8 to 7 in Table 3 below, it was observed that better Gain or optical power in a liquid crystal display can be obtained with machine direction orientation.

TABLE 3

| | | | Block State % | Pass State % | |
|---|---|---|---|---|---|
| Example # | % Haze | % Clarity | Transmission | Transmission | Gain |
| 1 | 62 | 65 | 7.8 | 82.4 | 1.48 |
| 2 | 58 | 69 | 13.7 | 84 | 1.45 |
| 3 | 84 | 31 | 19 | 80 | 1.38 |
| 4 | 55 | 47 | 8 | 82 | 1.47 |
| 5 | 74 | 39 | 20.7 | 80.3 | 1.4 |
| 6 | 56 | 47 | 14 | 81.3 | 1.45 |
| 7 | 64.7 | 47.1 | 13.2 | 86.4 | 1.41 |
| 8 | 56.4 | 45.2 | 13.4 | 83.9 | 1.46 |
| 9 | 48 | 84.1 | 18.9 | 91.5 | 1.44 |

Haze was measured using a Haze-Guard Plus haze meter from BYK-Gardner in accordance with typical procedures described in ASTM D1003-00. For the purposes of the present disclosure, the term “gain” or “optical gain” refers to the ratio of the axial output luminance of an optical system with an optical film constructed according to the present disclosure to the axial output luminance of the same optical system without such optical film.

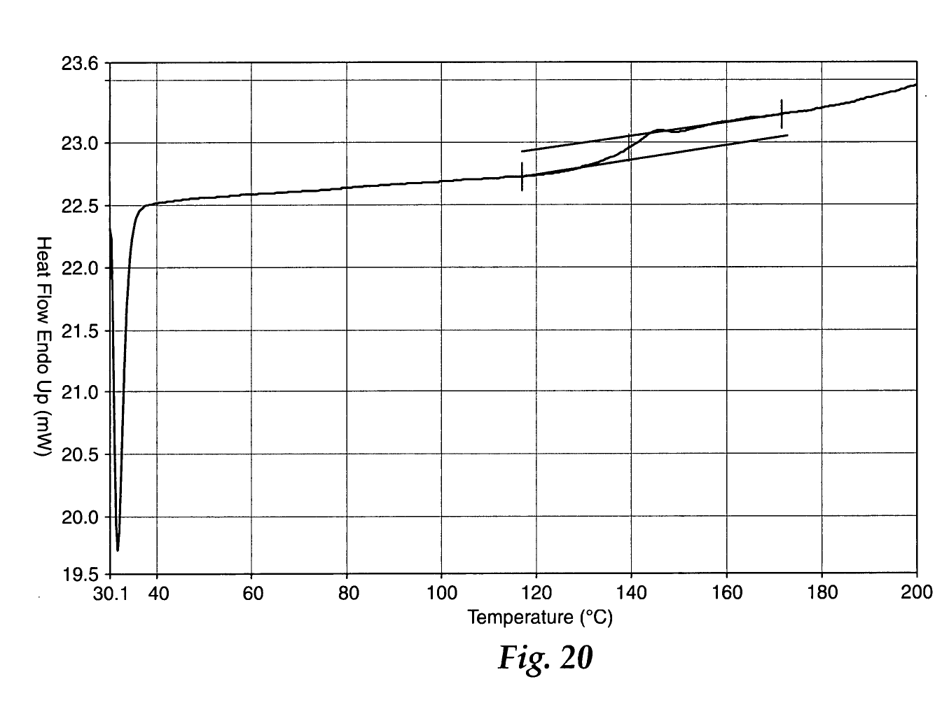

Clarity, which describes how well very fine detail may be resolved in an object, was also measured using a Haze-Guard Plus haze meter from BYK-Gardner. The glass transition temperature (Tg) of the blend was measured using Differential Scanning Calorimetry (DSC), and the resulting plot is shown in FIG. 20.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A polarizing film comprising a first phase of a first polymer and a second phase of a second polymer disposed within the first phase, and wherein an index of refraction difference between the first and second phases is greater than about 0.05 along a first axis and is less than about 0.05 along at least one axis orthogonal to the first axis, wherein a diffuse reflectivity of the first and second phases taken together along at least one axis for at least one polarization state of electromagnetic radiation is at least about 30%, and wherein the second phase has a refractive index of about 1.53 to about 1.59.

2. The polarizing film of claim 1, wherein the second phase has a refractive index of about 1.56 to about 1.58.

3. The polarizing film of claim 1, wherein the index of refraction difference between the first and second phases is greater than about 0.05 along a first axis and is less than about 0.05 along a second axis and third axis, wherein the second and third axes are orthogonal to the first axis.

4. The polarizing film of claim 1, wherein the second polymer is selected from the group consisting of polycarbonates (PC), copolycarbonates, polystyrene-polymethylmethacrylate copolymers (PS-PMMA), PS-PMMA-acrylate copolymers, polystyrene maleic anhydride copolymers, acrylonitrile butadiene styrene (ABS), ABS-PMMA, polyurethanes, polyamides, styrene-acrylonitrile polymers (SAN), polycarbonate/polyester blend resins, aliphatic copolyesters, polyvinyl chloride (PVC), and polychloroprene.

5. The polarizing film of claim 1, wherein the second polymer is a polycarbonate/polyester blend resin.

6. The polarizing film of claim 1, wherein the first polymer comprises a birefringent polyester.

7. The polarizing film of claim 1, wherein the first polymer is selected from the group consisting of PEN, copolymers of PEN and polyethylene terepthalate (PET), PET, polypropylene terephthalate, polypropylene naphthalate, polybutylene terephthalate, polybutylene naphthalate, polyhexamethylene terephthalate, and polyhexamethylene naphthalate.

8. The polarizing film of claim 1, wherein the first polymer comprises PEN or CoPEN, and the second polymer comprises polycarbonate or copolymers of polycarbonate.

9. A method of forming an optical film, comprising:
(a) forming a film comprising a first phase of a first polymer and a second phase of a second polymer dispersed in the first phase, wherein the second polymer has a refractive index of about 1.53 to about 1.59;
(b) conveying the film into a stretcher along a machine direction while holding opposing edge portions of the film, and;
(c) substantially uniaxially stretching the film within the stretcher by moving the opposing edge portions of the film along diverging paths, wherein following stretching an index of refraction difference between the first and second phases is greater than about 0.05 along a first axis in a plane parallel to a surface of the film, and less than about 0.05 along at least one axis orthogonal to the first axis.

10. The method of claim 9, wherein the opposing edge portions are moved along diverging, substantially parabolic paths.

11. The method of claim 9, wherein stretching the film comprises stretching the film under non-constant strain within the stretcher by moving the opposing edge portions along diverging, substantially parabolic paths to form a stretched film.

12. The method of claim 9, wherein the film has an initial thickness and initial width when conveyed into the stretcher and the stretched film has a stretched thickness and a stretched width; and wherein, after stretching the film to a ratio of stretched width/initial width defined as λ, a ratio of stretched thickness/initial thickness is approximately λ^{-1/2}.

13. The method of claim 9, wherein the step of stretching the film comprises stretching the film within the stretcher by moving the opposing edge portions along diverging, substantially parabolic paths, wherein the paths are coplanar.

14. The method of claim 9, wherein the step of stretching the film comprises stretching the film within the stretcher by moving the opposing edge portions along diverging, substantially parabolic paths, wherein the paths are substantially symmetrical about a center axis of the film.

15. The method of claim 9, wherein following stretching the index of refraction difference between the first and second phases is greater than about 0.05 along a first axis in a plane parallel to a surface of the film, less than about 0.05 along a second axis orthogonal to the first axis, and less than about 0.05 along a third axis orthogonal to the first and second axes.

16. A polarizing film comprising a continuous phase of a first birefringent polymer and a disperse phase of a second polymer, different from the first polymer, wherein an index of refraction difference between the continuous and disperse phases is greater than about 0.05 along a first axis in a plane parallel to a surface of the film, and less than about 0.05 along a second axis orthogonal to the first axis, and wherein the second polymer has a glass transition temperature (Tg) higher than a Tg of the birefringent first polymer.

17. The polarizing film of claim 16, wherein the index of refraction difference between the continuous and disperse phases is greater than about 0.05 along a first axis and is less than about 0.05 along a second axis and third axis, wherein the second and third axes are orthogonal to the first axis.

18. The polarizing film of claim 1, further comprising an absorbing polarizer material.

19. The method of claim 9, further comprising incorporating an absorbing polarizer material into the optical film.

20. The polarizing film of claim 16, further comprising an absorbing polarizer material.
